(19) United States
(12) Patent Application Publication
(10) Pub. No.: US 2025/0063576 A1
(43) Pub. Date: Feb. 20, 2025

(54) SIDELINK POSITIONING ASSISTANCE

(71) Applicant: Lenovo (Singapore) Pte. Limited, Singapore (SG)

(72) Inventors: Robin Rajan Thomas, Frankfurt (DE); Hyung-Nam Choi, Ottobrunn (DE)

(73) Assignee: Lenovo (Singapore) Pte. Limited, Singapore (SG)

(21) Appl. No.: 18/805,183

(22) Filed: Aug. 14, 2024

Related U.S. Application Data
(60) Provisional application No. 63/532,984, filed on Aug. 16, 2023.

(51) Int. Cl. H04W 72/25; H04L 5/00; H04W 64/00

(52) U.S. Cl. CPC H04W 72/25; H04L 5/0005; H04W 64/00

(57) ABSTRACT

Various aspects of the present disclosure relate to sidelink positioning assistance. An apparatus, such as a user equipment (UE), transmits a configuration message (e.g., to a network equipment) including an indication to perform one or more of sidelink positioning reference signal (SL-PRS) or SL positioning data message transmission, and the configuration message includes one or more SL positioning parameters. The apparatus receives a resource configuration message including a set of time-frequency resources in which to perform the one or more of the SL-PRS or SL positioning data message transmission.

### RELATED APPLICATION

This application claims priority to U.S. Provisional Application Ser. No. 63/532,984 filed 16 Aug. 2023 entitled “SIDELINK POSITIONING ASSISTANCE,” the disclosure of which is incorporated by reference herein in its entirety.

### TECHNICAL FIELD

The present disclosure relates to wireless communications, and more specifically to device positioning in wireless communications.

### BACKGROUND

A wireless communications system may include one or multiple network communication devices, such as base stations, which may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

In a wireless communications system determining a position of a UE can be important such as for emergency services. Current positioning techniques, however, may be imprecise and/or inefficient.

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”. Further, as used herein, including in the claims, a “set” may include one or more elements.

Some implementations of the method and apparatuses described herein may further include to transmit, from a UE to a network equipment (NE), a configuration message including an indication to perform one or more of sidelink positioning reference signal (SL-PRS) or SL positioning data message transmission, the configuration message including one or more SL positioning parameters; and receive, from the second apparatus, a resource configuration message including a set of time-frequency resources in which to perform the one or more of the SL-PRS or SL positioning data message transmission

In some implementations of the method and apparatuses described herein, the UE receives a higher-layer trigger to perform the one or more of the SL-PRS or SL positioning data message transmission; the higher-layer trigger includes one or more of sidelink positioning protocol (SLPP) layer, vehicle to everything (V2X) layer, ProSe layer, ranging layer, SL positioning layer, or sidelink positioning application layer; the UE receives the higher-layer trigger from another UE via one or more of: higher-layer signaling including one or more of sidelink positioning protocol (SLPP) layer, PC5 radio resource control (RRC), or PC5-S; or lower layer signaling including one or more of first stage sidelink control information (SCI), first stage medium access control (MAC) control element (CE), second stage SCI, or second stage MAC CE; the configuration message includes one or more of a SL positioning quality of service (QoS) profile, at least one transport QoS profile indicating SL positioning transport QoS parameters, a SL positioning session identifier, SL-PRS transmission characteristics, or one or more UE discovered for SL positioning.

In some implementations of the method and apparatuses described herein, the UE receives a system information message including one or more common SL positioning configurations, the one or more common SL positioning configurations including at least one of a SL positioning radio bearer configuration list, SL-PRS priority, positioning message priority, SL positioning frequency information list, SL-PRS/SL positioning area validity information or SL positioning measurement common information; the UE includes one or more of a target UE, an anchor UE, a server UE, or an apparatus configured to perform one or more of SL-PRS or SL positioning data message transmission; the configuration message includes one or more of: a SL positioning transmission resource request; at least one of a SL positioning receiver unicast, groupcast, or broadcast destination list; one or more of a SL positioning transmitter or receiver frequency list; SL positioning UE type; one or more SL positioning capabilities; a SL positioning transmission resource discovery request; a SL positioning destination identifier; a SL positioning cast type; or a coverage status of a discovered UE; the configuration message includes one or more of SL-PRS dedicated shared pools for at least one of mode 1 and Scheme 1 transmission or mode 2 and scheme 2 transmission; the configuration message includes one or more SL-PRS and SL communication data dedicated resource pools for at least one of mode 1 and Scheme 1 transmission or mode 2 and scheme 2 transmission; the configuration message includes a coverage status indication of a set of discovered UE, and wherein the coverage status indication includes whether each discovered UE is in coverage or out of coverage.

Some implementations of the method and apparatuses described herein may further include transmitting, from the UE to a NE, a configuration message including an indication to perform one or more of SL-PRS or SL positioning data message transmission, the configuration message including one or more SL positioning parameters; and receiving, from the NE, a resource configuration message including a set of time-frequency resources in which to perform the one or more of the SL-PRS or SL positioning data message transmission.

Some implementations of the method and apparatuses described herein further include receiving a higher-layer trigger to perform the one or more of the SL-PRS or SL positioning data message transmission; the higher-layer trigger includes one or more of sidelink positioning protocol (SLPP) layer, vehicle to everything (V2X) layer, ProSe layer, ranging layer, SL positioning layer, or sidelink positioning application layer; receiving the higher-layer trigger from a UE via one or more of: higher-layer signaling including one or more of sidelink positioning protocol layer (SLPP), PC5 RRC, or PC5-S; or lower layer signaling including one or more of first stage SCI, first stage MAC CE, second stage SCI, or second stage MAC CE; the configuration message includes one or more of a SL positioning QoS profile, at least one transport QoS profile indicating SL positioning transport QoS parameters, a SL positioning session identifier, SL-PRS transmission characteristics, or one or more UE discovered for SL positioning.

Some implementations of the method and apparatuses described herein further include receiving a system information message including one or more common SL positioning configurations, the one or more common SL positioning configurations including at least one of a SL positioning radio bearer configuration list, SL-PRS priority, positioning message priority, SL positioning frequency information list, SL-PRS/SL positioning validity configuration information including time-based (e.g., a timer, a validity time, and so forth) and/or area-based validity, e.g., zone information, physical cell identity (PCI), system information block (SIB) area validity, Cell identifiers (IDs), SL positioning measurement common information, etc.; the UE includes one or more of a target UE, an anchor UE, a server UE, or an apparatus configured to perform one or more of SL-PRS or SL positioning data message transmission; the configuration message includes one or more of: a SL positioning transmission resource request; at least one of a SL positioning receiver unicast, groupcast, or broadcast destination list; one or more of a SL positioning transmitter or receiver frequency list; SL positioning UE type; one or more SL positioning capabilities; a SL positioning transmission resource discovery request; a SL positioning destination identifier; a SL positioning cast type; or a coverage status of a discovered UE; the configuration message includes one or more of SL-PRS dedicated shared pools for at least one of mode 1 and Scheme 1 transmission or mode 2 and scheme 2 transmission; the configuration message includes one or more SL-PRS and SL communication data dedicated resource pools for at least one of mode 1 and Scheme 1 transmission or mode 2 and scheme 2 transmission; the configuration message includes a set of discovered UE, a coverage status indication of a set of discovered UE, and wherein the coverage status indication includes whether each discovered UE is in coverage or out of coverage.

Some implementations of the method and apparatuses described herein may further include to a processor to transmit, from a first apparatus to a second apparatus, a configuration message including an indication to perform one or more of SL-PRS or SL positioning data message transmission, the configuration message including one or more SL positioning parameters; and receive, from the second apparatus, a resource configuration message including a set of time-frequency resources in which to perform the one or more of the SL-PRS or SL positioning data message transmission.

In some implementations of the method and apparatuses described herein, the processor receives a higher-layer trigger to perform the one or more of the SL-PRS or SL positioning data message transmission; the higher-layer trigger includes one or more of sidelink positioning protocol (SLPP) layer, vehicle to everything (V2X) layer, ProSe layer, ranging layer, SL positioning layer, or sidelink positioning application layer; the at least one controller is configured to cause the processor to receive the higher-layer trigger from a UE via one or more of: higher-layer signaling including one or more of sidelink positioning protocol layer (SLPP), PC5 radio resource control (RRC), or PC5-S; or lower layer signaling including one or more of first stage SCI, first stage MAC CE, second stage SCI, or second stage MAC CE; the configuration message includes one or more of a SL positioning QoS profile, at least one transport QoS profile indicating SL positioning transport QoS parameters, a SL positioning session identifier, SL-PRS transmission characteristics, or one or more UE discovered for SL positioning; receive a system information message including one or more common SL positioning configurations, the one or more common SL positioning configurations including at least one of a SL positioning radio bearer configuration list, SL-PRS priority, positioning message priority, SL positioning frequency information list, SL-PRS/SL positioning area validity information or SL positioning measurement common information.

In some implementations of the method and apparatuses described herein, the first apparatus includes one or more of a target UE, an anchor UE, a server UE, or an apparatus configured to perform one or more of SL-PRS or SL positioning data message transmission; the configuration message includes one or more of: a SL positioning transmission resource request; at least one of a SL positioning receiver unicast, groupcast, or broadcast destination list; one or more of a SL positioning transmitter or receiver frequency list; SL positioning UE type; one or more SL positioning capabilities; a SL positioning transmission resource discovery request; a SL positioning destination identifier; a SL positioning cast type; or a coverage status of a discovered UE; the configuration message includes one or more of SL-PRS dedicated shared pools for at least one of mode 1 and Scheme 1 transmission or mode 2 and scheme 2 transmission; the configuration message includes one or more SL-PRS and SL communication data dedicated resource pools for at least one of mode 1 and Scheme 1 transmission or mode 2 and scheme 2 transmission; the configuration message includes a coverage status indication of a set of discovered UE, and wherein the coverage status indication includes whether each discovered UE is in coverage or out of coverage.

Some implementations of the method and apparatuses described herein may further include to receive, at an NE from a second apparatus, a configuration message including an indication to perform one or more of SL-PRS or SL positioning data message transmission, the configuration message including one or more SL positioning parameters; and transmit, to the second apparatus, a resource configuration message including a set of time-frequency resources in which to perform the one or more of the SL-PRS or SL positioning data message transmission.

In some implementations of the method and apparatuses described herein, the NE transmits a system information message including one or more common SL positioning configuration; the one or more common SL positioning configurations include at least one of a SL positioning radio bearer configuration list, SL-PRS priority, positioning message priority, SL positioning frequency information list, SL-PRS/SL positioning area validity information or SL positioning measurement common information.

Some implementations of the method and apparatuses described herein may further include receiving, at the NE and from a UE, a configuration message including an indication to perform one or more of SL-PRS or SL positioning data message transmission, the configuration message including one or more SL positioning parameters; and transmitting, to the UE, a resource configuration message including a set of time-frequency resources in which to perform the one or more of the SL-PRS or SL positioning data message transmission.

Some implementations of the method and apparatuses described herein may further include transmitting a system information message including one or more common SL positioning configurations; the one or more common SL positioning configurations include at least one of a SL positioning radio bearer configuration list, SL-PRS priority, positioning message priority, SL positioning frequency information list, SL-PRS/SL positioning area validity information or SL positioning measurement common information.

Some implementations of the method and apparatuses described herein may further include to generate a semi-static configuration of one or more SL-PRS transmission characteristics including one or more SL positioning or shared resource pools; and transmit the semi-static configuration to a UE.

In some implementations of the method and apparatuses described herein, the semi-static configuration is associated with one or more of a validity time or a validity area; the NE transmits the semi-static configuration as one or more of a solicited message or an unsolicited message; the NE transmits, to the UE, an indication of unavailability of SL positioning semi-static configuration; the SL-PRS transmission characteristics include one or more of: SL positioning dedicated resource pool identifier for one or more of Mode 1 or Scheme 1 SL-PRS transmission; SL positioning dedicated resource pool identifier for one or more of Mode 1 or Scheme 1 SL positioning transmission; SL positioning dedicated resource pool identifier for one or more of Mode 2 or Scheme 2 SL-PRS transmission; SL positioning dedicated resource pool identifier for one or more of Mode 2 or Scheme 2 SL positioning transmission; SL positioning shared resource pool identifier for one or more of Mode 1 or Scheme 1 SL-PRS positioning transmission; SL positioning shared resource pool identifier for one or more of Mode 1 or Scheme 1 SL positioning transmission; SL positioning shared resource pool identifier for one or more of Mode 2 or Scheme 2 SL-PRS positioning transmission; SL positioning shared resource pool identifier for one or more of Mode 2 or Scheme 2 SL positioning transmission; or SL-PRS resource index including one or more of SL-PRS bandwidth, SL-PRS comb size, SL-PRS periodicity, SL-PRS resource identifier, SL-PRS identifier, SL positioning session identifier, SL bandwidth part (BWP) identifier, SL carrier identifier, or SL-PRS repetitions;

In some implementations of the method and apparatuses described herein, the NE transmits the semi-static configuration via one or more of UE specific signaling or broadcast signaling; the NE activates the semi-static configuration via one or more of UE specific signaling or broadcast signaling; and deactivates the semi-static configuration via one or more of UE specific signaling or broadcast signaling.

Some implementations of the method and apparatuses described herein may further include generating, at a NE, a semi-static configuration of one or more SL-PRS transmission characteristics including one or more SL positioning or shared resource pools; and transmitting the semi-static configuration to a UE.

In some implementations of the method and apparatuses described herein, the semi-static configuration is associated with one or more of a validity time or a validity area; transmitting the semi-static configuration as one or more of a solicited message or an unsolicited message; transmitting, to the UE, an indication of unavailability of SL positioning semi-static configuration; the SL-PRS transmission characteristics include one or more of: SL positioning dedicated resource pool identifier for one or more of Mode 1 or Scheme 1 SL-PRS transmission; SL positioning dedicated resource pool identifier for one or more of Mode 1 or Scheme 1 SL positioning transmission; SL positioning dedicated resource pool identifier for one or more of Mode 2 or Scheme 2 SL-PRS transmission; SL positioning dedicated resource pool identifier for one or more of Mode 2 or Scheme 2 SL positioning transmission; SL positioning shared resource pool identifier for one or more of Mode 1 or Scheme 1 SL-PRS positioning transmission; SL positioning shared resource pool identifier for one or more of Mode 1 or Scheme 1 SL positioning transmission; SL positioning shared resource pool identifier for one or more of Mode 2 or Scheme 2 SL-PRS positioning transmission; SL positioning shared resource pool identifier for one or more of Mode 2 or Scheme 2 SL positioning transmission; or SL-PRS resource index including one or more of SL-PRS bandwidth, SL-PRS comb size, SL-PRS periodicity, SL-PRS resource identifier, SL-PRS identifier, SL positioning session identifier, SL BWP identifier, SL carrier identifier, or SL-PRS repetitions.

Some implementations of the method and apparatuses described herein include transmitting the semi-static configuration via one or more of UE specific signaling or broadcast signaling; one or more of: activating the semi-static configuration via one or more of UE specific signaling or broadcast signaling; or deactivating the semi-static configuration via one or more of UE specific signaling or broadcast signaling.

### BRIEF DESCRIPTION OF THE DRAWINGS

FIG. 1 illustrates an example of a wireless communications system in accordance with aspects of the present disclosure.

FIG. 2 illustrates an example of system for NR beam-based positioning in accordance with aspects of the present disclosure.

FIG. 3 illustrates example scenarios for absolute and relative positioning scenarios.

FIG. 4 illustrates an example of a multi-cell Round Trip Time (RTT) procedure in accordance with aspects of the present disclosure.

FIG. 5 illustrates an example of a system for relative range estimation using a gNB RTT positioning framework

FIG. 6 illustrates an example procedure to enable a UE to obtain sidelink positioning and/or ranging location results.

FIG. 7 illustrates a procedure to enable a location services (LCS) Client and/or an AF to obtain ranging and/or sidelink positioning location results for a group of n UEs.

FIG. 8 illustrates an example procedure for ranging and/or SL positioning control such as for UE-only operation.

FIG. 9 illustrates an example procedure for a device to initiate a request for SLPP message data exchange and/or SL-PRS transmission with the serving gNB in accordance with aspects of the present disclosure.

FIG. 10 illustrates an example of a procedure that supports sidelink positioning assistance in accordance with aspects of the present disclosure.

FIG. 11 illustrates an example of a procedure that supports sidelink positioning assistance in accordance with aspects of the present disclosure.

FIG. 12 illustrates an example of a procedure that supports sidelink positioning assistance in accordance with aspects of the present disclosure.

FIG. 13 illustrates an example of a UE in accordance with aspects of the present disclosure.

FIG. 14 illustrates an example of a processor in accordance with aspects of the present disclosure.

FIG. 15 illustrates an example of a NE in accordance with aspects of the present disclosure.

FIG. 16 illustrates a flowchart of a method performed by a UE in accordance with aspects of the present disclosure.

FIG. 17 illustrates a flowchart of a method performed by a NE in accordance with aspects of the present disclosure.

FIG. 18 illustrates a flowchart of a method performed by a NE in accordance with aspects of the present disclosure.

### DETAILED DESCRIPTION

SL positioning frameworks have been discussed to support varying target positioning parameters across different use cases. SL positioning, for example, is intended to be applied for a variety of use-cases such as V2X, public safety, IIoT and commercial use cases. One aim of SL positioning is to determine absolute and relative position of a UE by using SL positioning methods such as SL RTT-type methods including single-sided and double-sided RTT, SL-AoA and SL-time difference of arrival (TDOA). SL positioning can utilize new SL PRS that is transmitted over the PC5 interface and can be supported in various coverage scenarios (e.g., in-coverage, partial coverage, and out-of-coverage scenarios) and for PC5 only and joint PC5-Uu-based operation scenarios. Further, for exchanging SL positioning related information between UEs over the PC5 interface a new protocol denoted as SLPP has been discussed.

According to at least one Uu positioning framework, positioning assistance data delivery including DL-PRS (downlink positioning reference signal) configuration can be managed by a location server, e.g., LMF. The location server can initiate a PRS configuration (e.g., using a NRPPa PRS CONFIGURATION REQUEST message) to NG-RAN nodes including serving and neighboring gNBs to configure PRS resources and receive a response message, e.g., NRPPa PRS CONFIGURATION RESPONSE message from the applicable gNB. In scenarios such a PRS configuration can be semi-static in nature and may not change frequently unless requested to do so using an on-demand NRPPa PRS configuration procedure. In addition, the location server can request PRS configuration based on the knowledge of the received positioning QoS and subsequent selected positioning method.

However, due to the distributed nature of SL positioning and operation under different coverage scenarios and based on the legacy SL resource allocation procedures, various issues may arise. For instance, in some SL resource allocation procedures (e.g., related to the Mode 1/Scheme 1 centralized resource allocation) may involve the gNB and UE requesting resources for SL-PRS transmission. However, in such scenarios it remains unclear as to how the gNB will receive the positioning QoS and allocate the resources for SL positioning based on factors such as the involvement of the location server or with no involvement of the location server. Further, the mechanism for SL positioning assistance data delivery has as result not yet been addressed.

Accordingly, this disclosure presents systems, apparatuses and methods for enhanced SL mechanisms and procedures to enable SL positioning assistance data delivery in different scenarios with and without location server involvement and considering different types of coverage scenarios. Implementations discussed herein, for instance, address scenarios of no location server involvement and UE-only operation. In such scenarios a serving gNB may need to receive information about the positioning QoS and thereby allocate SL-PRS resources based on the number of UEs involved in a particular SL positioning session as well as the configured positioning technique. Further, the disclosed implementations are applicable in scenarios of location server involvement and based on the request and status information received by the location server, a location server can deliver the SL-PRS assistance data (e.g., Mode 1 and Mode 2 SL-PRS resources) to UE on a semi-static manner. Further, if the Mode 1 resources are dynamic, the location server can provide the SL-PRS assistance data to UEs in unsolicited manner including information such as validity time. In further implementations, if a UE requests SL PRS assistance data from the location server, the UE can add an indication about a list of discovered UEs and their status, e.g. whether the discovered UEs are in-coverage or out-of-coverage.

The described techniques, for example, enable initiation of the sharing of SL positioning information with an NG-RAN node including a request for SL-PRS and SL positioning resource configurations based on desired carrier frequencies for SL positioning transmission and reception, positioning QoS and transport QoS profiles for SL-PRS and/or SL positioning data messages is detailed. Further, the described techniques enable provision of semi-static SL positioning assistance data collected from multiple NG-RAN nodes by a location server, e.g., LMF. Still further, the described techniques provide indications of discovered UEs for a SL positioning session and an associated coverage status of the discovered UEs.

Accordingly, the described techniques are adaptable to a variety of different SL positioning scenarios and can increase an accuracy with which UE location can be determined. Aspects of the present disclosure are described in the context of a wireless communications system.

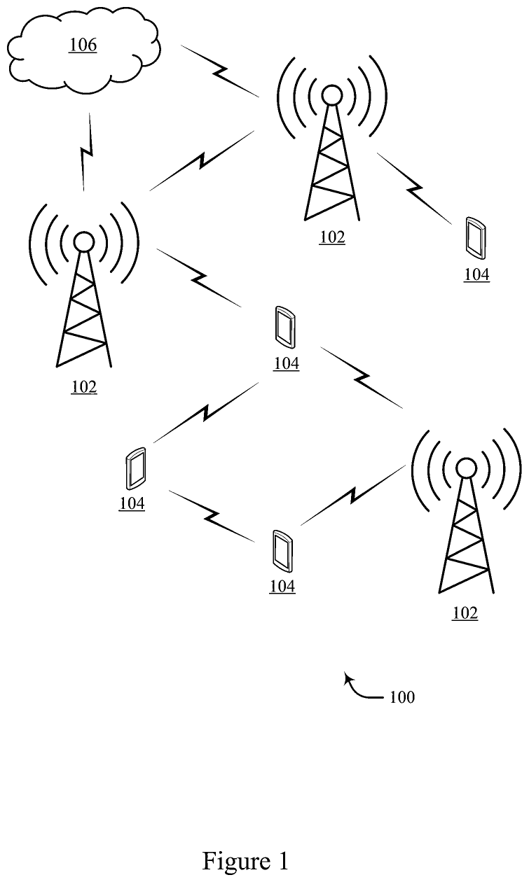

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., Orthogonal Frequency Division Multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

According to implementations, one or more of the NEs 102 and the UEs 104 are operable to implement various aspects of the techniques described with reference to the present disclosure. For example, a UE 104 transmits a configuration message to an NE 102 including an indication to perform one or more of SL-PRS or SL positioning data message transmission, and the configuration message includes one or more SL positioning parameters. The NE 102 can transmit to the UE 104 a resource configuration message including a set of time-frequency resources in which to perform the one or more of the SL-PRS or SL positioning data message transmission. The UE 104 can utilize the time-frequency resources to perform SL positioning, such as for the UE 104 itself and/or for a different UE.

With reference to positioning requirements, NR positioning based on NR Uu signals and stand-alone (SA) architecture (e.g., beam-based transmissions) was first specified in Release 16. The targeted use cases also included commercial and regulatory (emergency services) scenarios as in Release 15. The performance requirements are the following:

| Positioning Error | Indoor | Outdoor |
|---|---|---|
| Horizontal Positioning | <3 m for 80% of UEs | <10 m for 80% of UEs |
| Vertical Positioning | <3 m for 80% of UEs | <3 m for 80% of UEs |

Currently 3GPP Release 17 positioning has defined the positioning performance requirements for commercial and IIoT use cases as follows:

| Positioning Error | Commercial | IIoT |
|---|---|---|
| Horizontal Positioning | (<1 m) for 90% | (<0.2 m) for 90% |
| | of UEs | of UEs; |
| Vertical Positioning | (<3 m) for 90% | (<1 m) for 90% |
| | of UEs | of UEs |
| Physical layer latency | (<10 ms) | (<10 ms) |
| for position estimation | | |
| of UE | | |
| End-to-End Latency | (<100 ms) | (<100 ms, in the order of |
| for position estimation | | 10 ms is desired) |
| of UE | | |

For sidelink positioning in Release 18, various requirements were defined capturing a variety of use cases, as listed in the following table:

| SL | | | | |
|---|---|---|---|---|
| Positioning | | | | |
| KPIs | V2X | Public Safety | IIoT | Commercial |
| Horizontal | Set A (similar to | 1 m for 90% of | Set A: 1 m | 1 m for 90% of |
| Positioning | “Set 2” defined in | UEs (absolute or | for 90% of | UEs (absolute |
| Accuracy | [2]): 1.5 m for | relative) | UEs (absolute | or relative) |
| | 90% of UEs | | or relative) | |
| | (absolute or | | Set B: 0.2 m | |
| | relative) | | for 90% of | |
| | Set B (similar to | | UEs (absolute | |
| | “Set 3” defined in | | or relative) | |
| | [2]): 0.5 m for | | | |
| | 90% of UEs | | | |
| | (absolute or | | | |
| | relative) | | | |
| Vertical | Set A: 3 m for | 2 m (absolute or | Set A: 1 m | 2 m for 90% of |
| Positioning | 90% of UEs | relative between | for 90% of | UEs (absolute |
| Accuracy | (absolute or | 2 UEs) for 90% | UEs (absolute | or relative) |
| | relative) | of UEs | or relative) | |
| | Set B: 2 m for | 0.3 m (relative | Set B: 0.2 m | |
| | 90% of UEs | positioning | for 90% of | |
| | (absolute or | change for 1 UE) | UEs (absolute | |
| | relative) | for 90% of UEs | or relative) | |
| Relative | — | Up to 30 km/h | Up to 30 km/h | Up to 30 km/h |
| Speed | | | | |

| | |
|---|---|
| Angle | Set A: Y = ±15° for 90% of the UEs |
| Accuracy | Set B: Y = ±8° for 90% of the UEs |

NOTE 1:
For evaluated SL positioning methods, the performance results are described in terms of whether each of the two requirements are satisfied, and the percentile of UEs satisfying the target positioning accuracy for a requirement that may not be satisfied with 90%.
NOTE 2:
Target positioning requirements may not necessarily be reached for all scenarios and deployments
NOTE 3:
All positioning techniques may not achieve all positioning requirements in all scenarios.

The supported UE positioning techniques are listed in the following Table 1:

| | | UE- | NG-RAN | |
|---|---|---|---|---|
| | UE- | assisted, | node | |
| Method | based | LMF-based | assisted | SUPL |
| A-GNSS | Yes | Yes | No | Yes (UE-based and |
| | | | | UE-assisted) |
| OTDOA ^{Notes1,2} | No | Yes | No | Yes (UE-assisted) |
| E-CID ^{Note 4} | No | Yes | Yes | Yes for E-UTRA |
| | | | | (UE-assisted) |
| Sensor | Yes | Yes | No | No |
| WLAN | Yes | Yes | No | Yes |
| Bluetooth | No | Yes | No | No |
| TBS ^{Note 5} | Yes | Yes | No | Yes (MBS) |
| DL-TDOA | Yes | Yes | No | No |
| DL-AoD | Yes | Yes | No | No |
| Multi-RTT | No | Yes | Yes | No |
| NR E-CID | No | Yes | FFS | No |
| UL-TDOA | No | No | Yes | No |
| UL-AoA | No | No | Yes | No |

^{Notes1}: This includes TBS positioning based on PRS signals.
^{Notes2}: In this version of the specification only observed time difference of arrival (OTDOA) based on LTE signals is supported.
^{Note 4}:
This includes Cell-ID for NR method.
^{Note 5}:
In this version of the specification is for TBS positioning based on metropolitan beacon system (MBS) signals.

Separate positioning techniques as indicated in the table above can be currently configured and performed based on the requirements of the LMF and UE capabilities. The transmission of Uu (uplink and downlink) PRSs enable the UE to perform UE positioning-related measurements to enable the computation of a UE's absolute location estimate and are configured per transmission reception point (TRP), where a TRP may include a set of one or more beams.

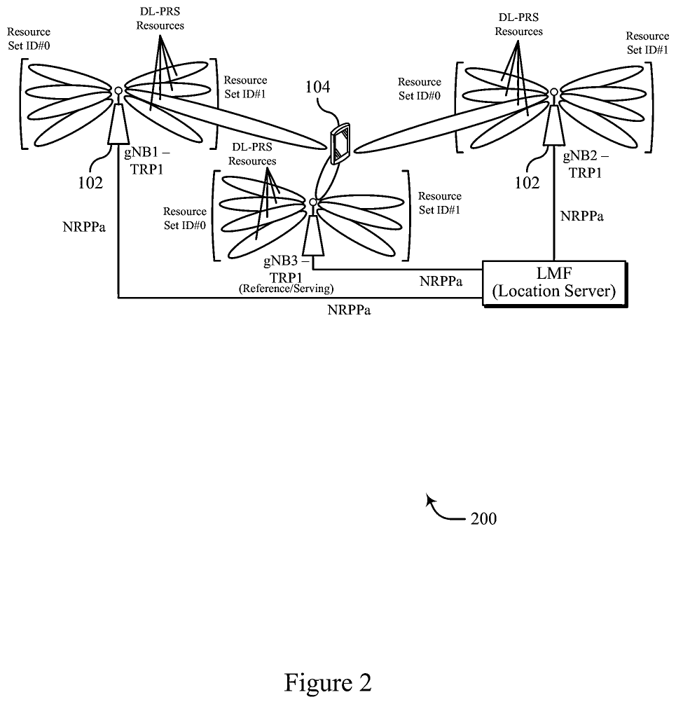

FIG. 2 illustrates an example of system 200 for NR beam-based positioning in accordance with aspects of the present disclosure. The system 200 illustrates a UE 104 and network entities 102 (e.g., gNBs). The PRS can be transmitted by different base stations (serving and neighboring) using narrow beams over FR1 and FR2 as illustrated in the example system 200, which is relatively different when compared to LTE where the PRS was transmitted across the whole cell. The PRS can be locally associated with a PRS Resource identifier (ID) and Resource Set ID for a base station (e.g., a TRP). Similarly, UE positioning measurements, such as reference signal time difference (RSTD) and PRS reference signal received power (RSRP) measurements are made between beams (e.g., between a different pair of downlink (DL) PRS resources or DL PRS resource sets) as opposed to different cells as was the case in LTE. In addition, there are additional uplink positioning methods for the network to exploit in order to compute the target-UE's location.

The tables below show the reference signal (RS) to measurements mapping for each of the supported RAT-dependent positioning techniques at the UE and gNB, respectively. The RAT-dependent positioning techniques may utilize the 3GPP RAT and core network entities to perform the position estimation of the UE, which are differentiated from RAT-independent positioning techniques, which rely on the Global Navigation Satellite System (GNSS), inertial measurement unit (IMU) sensor, wireless local area network (WLAN), and Bluetooth technologies for performing target device (UE) positioning.

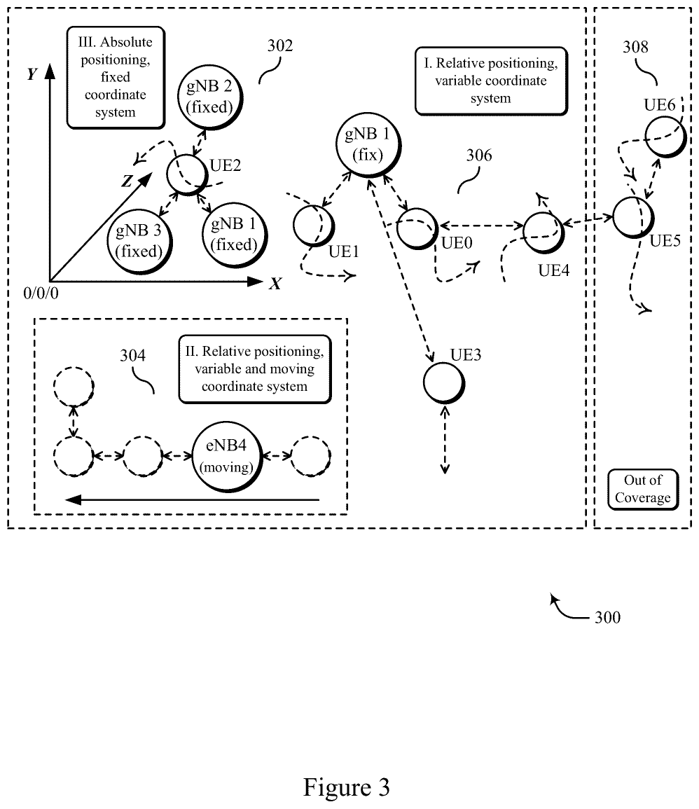

FIG. 3 illustrates example scenarios 300 for absolute and relative positioning scenarios. The scenarios 300, for instance, as defined in the system architectural (stage 1) study reported in technical report (TR) 22.832 using three different coordinate systems including Absolute Positioning (e.g., fixed coordinate systems), Relative Positioning (e.g., variable and moving coordinate systems), and Relative Positioning, e.g., variable coordinate systems.

TABLE 2
UE measurements to enable RAT-
dependent positioning techniques.

| | | To facilitate |
|---|---|---|
| DL/UL | | support of |
| Reference | | the positioning |
| Signals | UE Measurements | techniques |
| Rel. 16 DL PRS | DL RSTD | DL-TDOA |
| Rel. 16 DL PRS | DL PRS RSRP | DL-TDOA, |
| | | DL-AoD, |
| | | Multi-RTT |
| Rel. 16 DL PRS/Rel.16 | UE Rx-Tx time | Multi-RTT |
| SRS for positioning | difference | |
| Rel. 15 SSB/CSI-RS | SS-RSRP(RSRP for RRM), | NR E-CID |
| for RRM | SS-RSRQ(for RRM), | |
| | CSI-RSRP (for RRM), | |
| | CSI-RSRQ (for RRM), | |
| | SS-RSRPB (for RRM) | |

TABLE 3
gNB measurements to enable RAT-dependent
positioning techniques.

| | | To facilitate support |
|---|---|---|
| DL/UL Reference | gNB | of the positioning |
| Signals | Measurements | techniques |
| Rel. 16 SRS for | UL RTOA | UL-TDOA |
| positioning | | |
| Rel. 16 SRS for | UL SRS-REFERENCE | UL-TDOA, UL-AoA, |
| positioning | SIGNAL RECEIVED | Multi-RTT |
| | POWER (RSRP) | |
| Rel. 16 SRS for | gNB Rx-Tx time | Multi-RTT |
| positioning, Rel. 16 | difference | |
| DL PRS | | |
| Rel. 16 SRS for | AoA and ZoA | UL-AoA, |
| positioning | | Multi-RTT |

Various RAT-dependent positioning techniques are supported in Release 16 and Release 17, such as DL-TDoA, DL-AoD, Multi-RTT, enhanced cell-ID (E-CID)/NR E-CID, uplink (UL)-TDoA, and UL-AoA. The downlink time difference of arrival (DL-TDOA) positioning method makes use of the DL RSTD (and optionally DL PRS RSRP) of downlink signals received from multiple TPs, at the UE. The UE measures the DL RSTD (and optionally DL PRS RSRP) of the received signals using assistance data received from the positioning server, and the resulting measurements are used along with other configuration information to locate the UE in relation to the neighboring TPs.

The DL AoD positioning method makes use of the measured DL PRS RSRP of downlink signals received from multiple TPs, at the UE. The UE measures the DL PRS RSRP of the received signals using assistance data received from the positioning server, and the resulting measurements are used along with other configuration information to locate the UE in relation to the neighboring TPs. The Multi-RTT positioning method makes use of the UE Rx-Tx measurements and DL PRS RSRP of downlink signals received from multiple TRPs, measured by the UE and the measured gNB Rx-Tx measurements and UL sounding reference signal (SRS)—RSRP at multiple TRPs of uplink signals transmitted from UE.

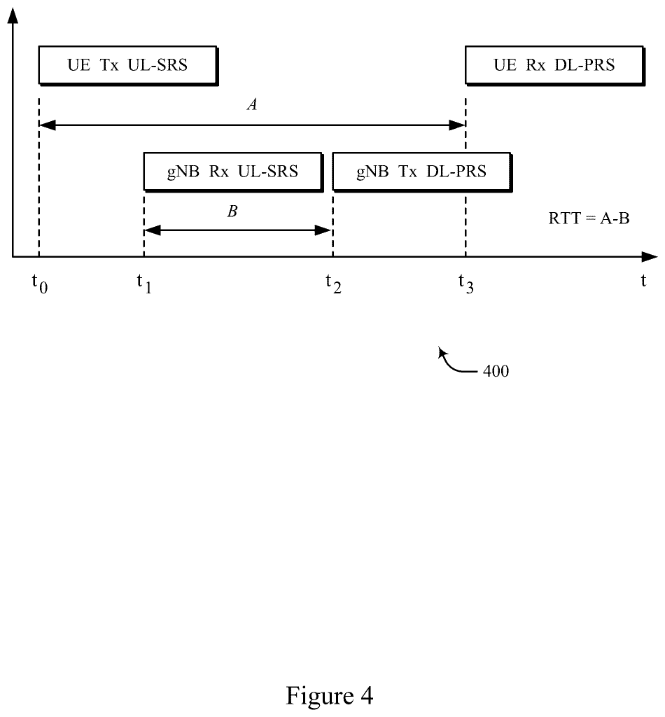

FIG. 4 illustrates an example 400 of a multi-cell RTT procedure as related to carrier phase positioning configuration in accordance with aspects of the present disclosure. The multi-RTT positioning technique makes use of the UE Rx-Tx measurements and DL PRS RSRP of downlink signals received from multiple TRPs, as measured by the UE and the measured gNB Rx-Tx measurements and uplink SRS RSRP (UL SRS—RSRP) at multiple TRPs of uplink signals transmitted from UE. The UE measures the UE Rx-Tx measurements (and optionally DL PRS RSRP of the received signals) using assistance data received from the positioning server (also referred to herein as the location server), and the TRPs the gNB Rx-Tx measurements (and optionally UL SRS—RSRP of the received signals) using assistance data received from the positioning server. The measurements are used to determine the RTT at the positioning server, which are used to estimate the location of the UE. In Release 16 the multi-RTT is only supported for UE-assisted and NG-RAN assisted positioning techniques as noted in Table 1.

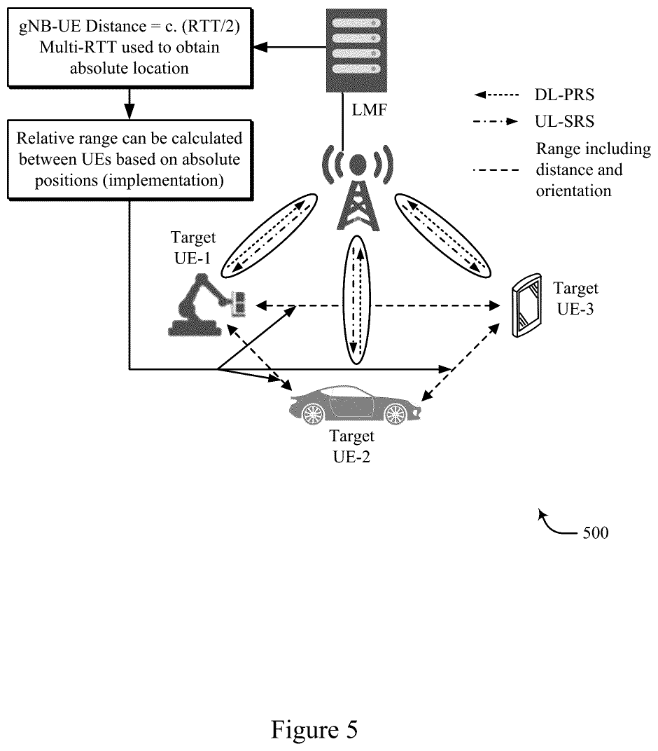

FIG. 5 illustrates an example of a system 500 for relative range estimation using a gNB RTT positioning framework as related to carrier phase positioning configuration.

For the NR enhanced cell ID (E-CID) positioning technique, the position of a UE is estimated with the knowledge of its serving ng-eNB, gNB, and cell, and is based on LTE signals. The information about the serving ng-eNB, gNB, and cell may be obtained by paging, registration, or other methods. The NR E-CID positioning refers to techniques which use additional UE measurements and/or NR radio resources and other measurements to improve the UE location estimate using NR signals. Although E-CID positioning may utilize some of the same measurements as the measurement control system in the RRC protocol, the UE may not make additional measurements for the sole purpose of positioning (e.g., the positioning procedures do not supply a measurement configuration or measurement control message, and the UE reports the measurements that it has available rather than being required to take additional measurement actions).

The uplink time difference of arrival (UL-TDOA) positioning technique makes use of the UL-relative time-of-arrival (RTOA) (and optionally UL SRS—RSRP) at multiple reception points (RPs) of uplink signals transmitted from UE. The RPs measure the UL-RTOA (and optionally UL SRS—RSRP) of the received signals using assistance data received from the positioning server, and the resulting measurements are used along with other configuration information to estimate the location of the UE.

The uplink angle of arrival (UL-AoA) positioning technique makes use of the measured azimuth and the zenith of arrival at multiple RPs of uplink signals transmitted from UE. The RPs measure azimuth-AoA (A-AoA) and zenith-AoA (Z-AoA) of the received signals using assistance data received from the positioning server (also referred to herein as the location server), and the resulting measurements are used along with other configuration information to estimate the location of the UE.

Various RAT-independent positioning techniques may also be used, such as network-assisted GNSS techniques, barometric pressure sensor positioning, WLAN positioning, Bluetooth positioning, terrestrial beacon system (TBS) positioning, and motion sensor positioning. Network-assisted GNSS techniques make use of UEs that are equipped with radio receivers capable of receiving GNSS signals. In 3GPP specifications the term GNSS encompasses both global and regional/augmentation navigation satellite systems. Examples of global navigation satellite systems include Global Positioning System (GPS), Modernized GPS, Galileo, Global Navigation Satellite System (GLONASS), and BeiDou Navigation Satellite System (BDS). Regional navigation satellite systems include Quasi Zenith Satellite System (QZSS) while the many augmentation systems are classified under the generic term of Space Based Augmentation Systems (SBAS) and provide regional augmentation services. Network-assisted GNSS techniques may use different GNSSs (e.g., GPS, Galileo, etc.) separately or in combination to determine the location of a UE.

Barometric pressure sensor positioning techniques make use of barometric sensors to determine the vertical component of the position of the UE. The UE measures barometric pressure, optionally aided by assistance data, to calculate the vertical component of its location or to send measurements to the positioning server for position calculation. This technique should be combined with other positioning methods to determine the 3D position of the UE.

WLAN positioning techniques makes use of the WLAN measurements (access point (AP) identifiers and optionally other measurements) and databases to determine the location of the UE. The UE measures received signals from WLAN access points, optionally aided by assistance data, to send measurements to the positioning server for position calculation. Using the measurement results and a references database, the location of the UE is calculated. Additionally or alternatively, the UE makes use of WLAN measurements and optionally WLAN AP assistance data provided by the positioning server to determine its location.

Bluetooth positioning techniques makes use of Bluetooth measurements (beacon identifiers and optionally other measurements) to determine the location of the UE. The UE measures received signals from Bluetooth beacons. Using the measurement results and a references database, the location of the UE is calculated. The Bluetooth methods may be combined with other positioning methods (e.g., WLAN) to improve positioning accuracy of the UE.

TBS positioning techniques make use of a TBS, which includes a network of ground-based transmitters, broadcasting signals only for positioning purposes. Examples of types of TBS positioning signals are MBS (Metropolitan Beacon System) signals and PRSs. The UE measures received TBS signals, optionally aided by assistance data, to calculate its location or to send measurements to the positioning server for position calculation.

Motion sensor positioning techniques makes use of different sensors such as accelerometers, gyros, magnetometers, and so forth to calculate the displacement of UE. The UE estimates a relative displacement based upon a reference position and/or reference time. The UE sends a report comprising the determined relative displacement which can be used to determine the absolute position. This method can be used with other positioning methods for hybrid positioning.

Different downlink measurements used for RAT-dependent positioning techniques include including DL PRS—RSRP, DL RSTD and UE Rx-Tx Time Difference. The following measurement configurations may be used: 4 Pair of DL RSTD measurements can be performed per pair of cells, and each measurement is performed between a different pair of DL PRS Resources/Resource Sets with a single reference timing; 8 DL PRS RSRP measurements can be performed on different DL PRS resources from the same cell.

TABLE 4
Downlink measurements for downlink-based positioning techniques.
DL PRS reference signal received power (DL PRS-RSRP)

| | |
|---|---|
| Definition | DL PRS-RSRP, is the linear average over the power contributions (in [W]) of |
| | the resource elements that carry DL PRS reference signals configured for |
| | RSRP measurements within the considered measurement frequency |
| | bandwidth. |
| | For frequency range 1, the reference point for the DL PRS-RSRP shall be the |
| | antenna connector of the UE. For frequency range 2, DL PRS-RSRP shall be |
| | measured based on the combined signal from antenna elements corresponding |
| | to a given receiver branch. For frequency range 1 and 2, if receiver diversity is |
| | in use by the UE, the reported DL PRS-RSRP value shall not be lower than |
| | the corresponding DL PRS-RSRP of any of the individual receiver branches. |
| Applicable for | RRC_CONNECTED intra-frequency, |
| | RRC_CONNECTED inter-frequency |

DL reference signal time difference (DL RSTD)

| | |
|---|---|
| Definition | DL reference signal time difference (DL RSTD) is the DL relative timing |
| | difference between the positioning node j and the reference positioning node i, |
| | defined as T_{SubframeRxj} − T_{SubframeRxi}, |
| | Where: |
| | T_{SubframeRxj} is the time when the UE receives the start of one subframe from |
| | positioning node j. |
| | T_{SubframeRxi} is the time when the UE receives the corresponding start of one |
| | subframe from positioning node i that is closest in time to the subframe |
| | received from positioning node j. |
| | Multiple DL PRS resources can be used to determine the start of one subframe |
| | from a positioning node. |
| | For frequency range 1, the reference point for the DL RSTD shall be the |
| | antenna connector of the UE. For frequency range 2, the reference point for |
| | the DL RSTD shall be the antenna of the UE. |
| Applicable for | RRC_CONNECTED intra-frequency |
| | RRC_CONNECTED inter-frequency |

UE Rx − Tx time difference

| | |
|---|---|
| Definition | The UE Rx − Tx time difference is defined as T_{UE-RX} − T_{UE-TX} |
| | Where: |
| | T_{UE-RX} is the UE received timing of downlink subframe #i from a positioning |
| | node, defined by the first detected path in time. |
| | T_{UE-TX} is the UE transmit timing of uplink subframe #j that is closest in time to |
| | the subframe #i received from the positioning node. |
| | Multiple DL PRS resources can be used to determine the start of one subframe |
| | of the first arrival path of the positioning node. |
| | For frequency range 1, the reference point for T_{UE-RX} measurement shall be the |
| | Rx antenna connector of the UE and the reference point for T_{UE-TX} |
| | measurement shall be the Tx antenna connector of the UE. For frequency |
| | range 2, the reference point for T_{UE-RX} measurement shall be the Rx antenna of |
| | the UE and the reference point for T_{UE-TX} measurement shall be the Tx antenna |
| | of the UE. |
| Applicable for | RRC_CONNECTED intra-frequency |
| | RRC_CONNECTED inter-frequency |

DL PRS RSRPP (Reference Signal Received Path Power)

| | |
|---|---|
| Definition | DL PRS reference signal received path power (DL PRS-RSRPP), is defined as |
| | the power of the linear average of the channel response at the i-th path delay |
| | of the resource elements that carry DL PRS signal configured for the |
| | measurement, where DL PRS-RSRPP for the 1st path delay is the power |
| | contribution corresponding to the first detected path in time. |
| | For frequency range 1, the reference point for the DL PRS-RSRPP shall be the |
| | antenna connector of the UE. For frequency range 2, DL PRS-RSRPP shall be |
| | measured based on the combined signal from antenna elements corresponding |
| | to a given receiver branch. |
| Applicable for | RRC_CONNECTED |
| | RRC_INACTIVE |

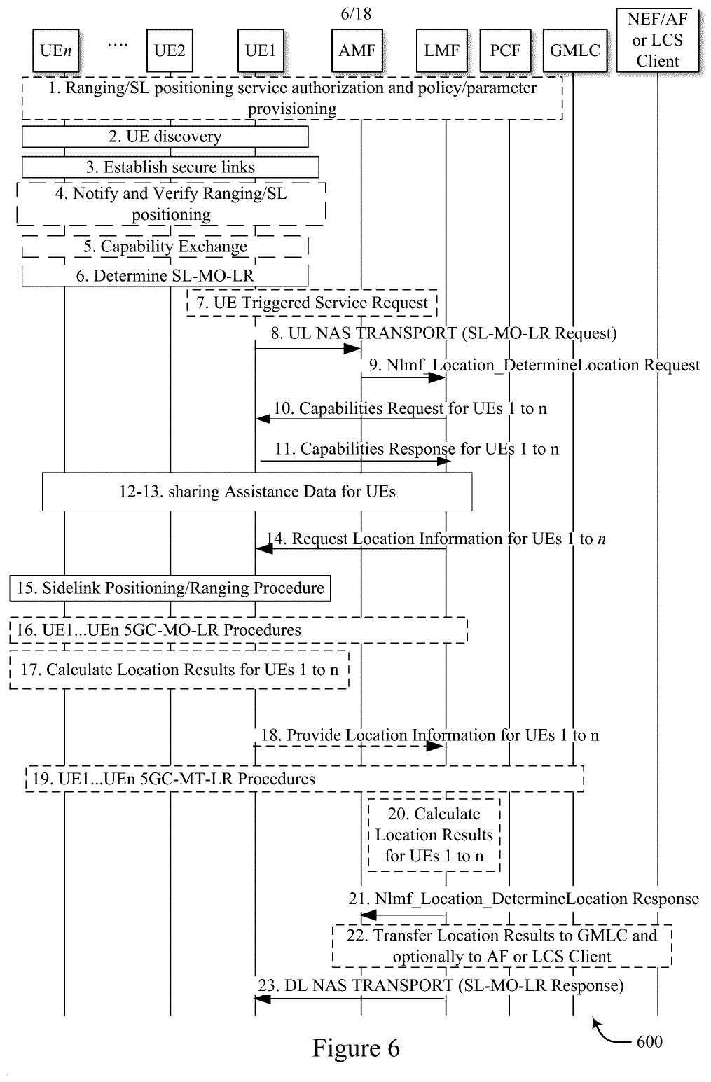

FIG. 6 illustrates an example procedure 600 to enable a UE to obtain sidelink positioning and/or ranging location results. The procedure 600, for instance, can use one or more other UEs with the assistance of an LMF in a serving Public Land Mobile Network (PLMN) for UE1. In the procedure 600 the ranging/SL positioning location results may include absolute locations, relative locations or distances and directions, such as based on the service request. Further, if the target UE decides to initiate a SL Mobile Originated Location Request (MO-LR) procedure, it can include one or multiple SL reference UE(s) and/or located UE (s) in the service request. For instance, see technical specification (TS) 23.586.

In the procedure 600, a UE1 can be in coverage and registered with a serving PLMN. UEs 2 to n may or may not be in coverage and, if in coverage, may or may not be registered with the same serving PLMN as UE1.
1. The procedures and signaling specified in clause 6.2 of TS 23.586 may be used to provision the Ranging/SL positioning service authorization and policy/parameter provisioning to UEs 1 to n, when in coverage.
   NOTE 1: If indication of UE-only operation is received, procedures of Ranging/Sidelink Positioning control as defined in clause 6.8 of TS 23.586 can be performed.
2. Based on a trigger of service request (e.g. received from the application layer), which includes UE1/ . . . /UE n, UE discovery is performed for Ranging/SL positioning as specified in clause 6.4 of TS 23.586:
   If UE1 is the target UE, UE1 discovers UEs 2 to n
   If UE1 is the Located UE, the target UE (i.e. one of the UEs 2 to n) discovers UE1 (and other Located UEs in the set of UEs 2 to n).
3. Secure groupcast and/or unicast links are established between UEs 1 to n as defined in clause 5.3 of TS 23.586 to enable UE1 to exchange Ranging and Sidelink Positioning Protocol (RSPP) messages over PC5-U reference point with each of UEs 2 to n and possibly enabling UEs 2 to n to exchange RSPP over PC5-U between each other.
4. UE1 and UEs 2 to n may communicate over PC5 for authorization of Ranging/SL positioning and receiving QoS parameters if needed. Each of UEs verifies that Ranging/SL positioning is permitted, including whether Ranging/SL positioning results may be transferred to an LCS Client or AF if this is used, according to any service authorization and policy/parameter provisioning received at step 1. QoS requirements for the Ranging/SL positioning may be also provided based on QoS requirements in the service request.
5. UE1 may obtain the Sidelink positioning capabilities of UEs 2 to n using the groupcast and/or unicast links established in step 3.
   Step 4 and 5 may be performed to transfer the information of UEs which are not served by the LMF.
6. Based on the Sidelink positioning capabilities of UE1/ . . . /UEn, the target UE determines SL-MO-LR is to be performed. If UE1 is the Located UE (i.e. when the target UE is one of UE2/ . . . /UEn and does not have NAS connection), the target UE initiates SL-MO-LR service request to UE1.
7. If UE1 is in connection management (CM)-IDLE state, UE1 instigates a UE triggered Service Request in order to establish a signaling connection with the serving AMF of UE1.
8. UE1 sends a supplementary services SL-MO-LR request to the serving AMF in an UL NAS TRANSPORT message. The SL-MO-LR request indicates the other UEs 2 to n (using application layer ID and/or Generic Public Subscription Identifier (GPSI)), indicates any assistance data needed, indicates whether location calculation assistance is needed, and indicates whether location results should be transferred to an LCS client or AF. The message shall include the identity of the LCS client or the AF and may include the address of the Gateway Mobile Location Centre (GMLC) through which the LCS client or AF (via Network Exposure Function (NEF)) should be accessed. In addition, a Service Type indicates which MO-LR service of the LCS Client is requested by the UE may be included. For location calculation assistance from the LMF, the preferred type of Sidelink positioning/ranging location results (e.g. absolute locations, relative locations or distances and directions between pairs of UEs) and the required QoS are included. If UE1 is Located UE and one of UE2/ . . . /UE n is the target UE that does not have NAS connection, the supplementary services SL-MO-LR request includes an indication that one of UE2/ . . . /UEn is the target UE instead of UE1.
9. The serving AMF selects an LMF serving UE1 (e.g. an LMF that supports Sidelink positioning/ranging) and sends an Nlmf_Location_DetermineLocation service operation towards the LMF with the information from the SL-MO-LR Request. The service operation includes a LCS Correlation identifier.
10. The LMF sends a request to UE1 for the capabilities of UEs 1 to n.
NOTE 3: UE2/ . . . /UE n is not assumed to be served by the same LMF serving UE1.
11. UE 1 returns its capabilities to the LMF. UE1 may additionally return the capabilities of the UEs obtained at step 5 if requested by the LMF at step 10.
12. UE1 may send a request for specific assistance data to the LMF.
13. LMF sends the requested assistance data to UE1, and UE1 forwards the assistance data received from LMF to UE2/ . . . /UEn. The assistance data may assist UEs 1 to n to obtain sidelink location measurements at step 15 and/or may assist UE1 to calculate Sidelink positioning/ranging location results at step 16.
   NOTE 4: Steps 10 and 11 can be omitted if UE1 includes a message containing the capabilities of UEs 1 to n in the SL-MO-LR request at step 8. Step 12 can be omitted if UE1 includes a message containing the request for specific assistance data in the SL-MO-LR request at step 8.
14. If the SL-MO-LR request at step 8 indicated location calculation assistance is needed and/or indicated transfer of sidelink positioning/ranging location results to an LCS Client or AF, the LMF sends a request for location information to UE1 and may also send a request for location information to UE2/ . . . /UEn if it is served by the LMF. If LMF determines to apply UE based SL Positioning, LMF includes in the request the indication of UE based SL Positioning. LMF may also provide the list of candidate Located UE(s), if absolute location is requested at step 8. If scheduled location time is received at step 14. LMF may include a scheduled location time.
15. UE1 instigates a Sidelink positioning/ranging procedure among UEs 1 to n in which UEs 1 to n obtain Sidelink location measurements and UEs 2 to n transfer their Sidelink location measurements to UE 1 and/or to the LMF (depending on the assistance requested). If scheduled location time is received at step 14, Sidelink positioning/ranging is performed at the scheduled location time.
16. If Target UE's absolute location information is required at step 8 and if absolute location of Located UE(s) is not available, the Target UE sends a request to the Located UE(s) to trigger 5GC-MO-LR procedure to let the Located UE(s) acquire their own absolute location. The QoS requirement received at step 8 is included in the request, which is used to derive the QoS for Located UE(s) positioning.
17. If LMF determines to use UE based calculation, at least one of UE1/ . . . /UEn calculates Sidelink positioning/ranging location results based on the Sidelink location measurements obtained at step 15 and possibly using assistance data received at step 13. The Sidelink positioning/ranging location results can include absolute locations, relative locations or ranges and directions related to the UEs 1 to n.
18. If UE1 received a request for location information at step 14, UE1 sends a response to the LMF and includes the Sidelink location measurements obtained at step 15, the Sidelink positioning/ranging location results obtained at step 17 if step 17 was performed or Located UE's absolute location obtained at step 16.
19. If Target UE's absolute location information is required at step 8 and if absolute location of Located UE(s) is not received at step 18, LMF can either retrieved the location of the Located UE(s) locally or triggers 5GC-Mobile Terminated Location Request (MT-LR) procedure to the GMLC to acquire the absolute location of the Located UE(s) using Application Layer ID or GPSI of the Located UE(s). LMF includes the QoS requirement received at step 8 in the request, which is used to derive the QoS for Located UE(s) positioning. If scheduled location time is used, LMF includes the scheduled location time in the request to GMLC.
20. The LMF calculates Sidelink positioning/ranging location results for UEs 1 to n from the Sidelink location measurements received at step 18 and absolute location of Located UE(s) at step 19. The Sidelink positioning/ranging location results can include absolute locations, relative locations or ranges and directions related to the UEs 1 to n, depending on the location request received in step 8.
21. The LMF returns an Nlmf_Location_DetermineLocation service operation response to the AMF and includes the Sidelink positioning/ranging location results received at step 18 or calculated at step 20.
22. If Sidelink positioning/ranging location results were received at step 21, the AMF performs steps 7-12 of clause 6.2 to send the Sidelink positioning/ranging location results to the GMLC and to an AF or LCS Client if this was requested at step 8. The Sidelink positioning/ranging location results include the identities for the respective UEs 1 to n received at step 8.
   NOTE 5: Sending location results and global identities for UEs 1 to n to an AF or LCS Client may require privacy verification from UEs 1 to n and/or from the HPLMNs of UEs 1 to n.
23. The LMF returns a supplementary services SL-MO-LR response to UE1 in a DL NAS TRANSPORT message and includes any Sidelink positioning/ranging location results calculated at step 20 if step 20 was performed. If UE1 is Located UE, and the target UE is one of the UEs 2 to n and does not have NAS connection, then UE1 may transfer the Sidelink positioning/ranging location results to the target UE.

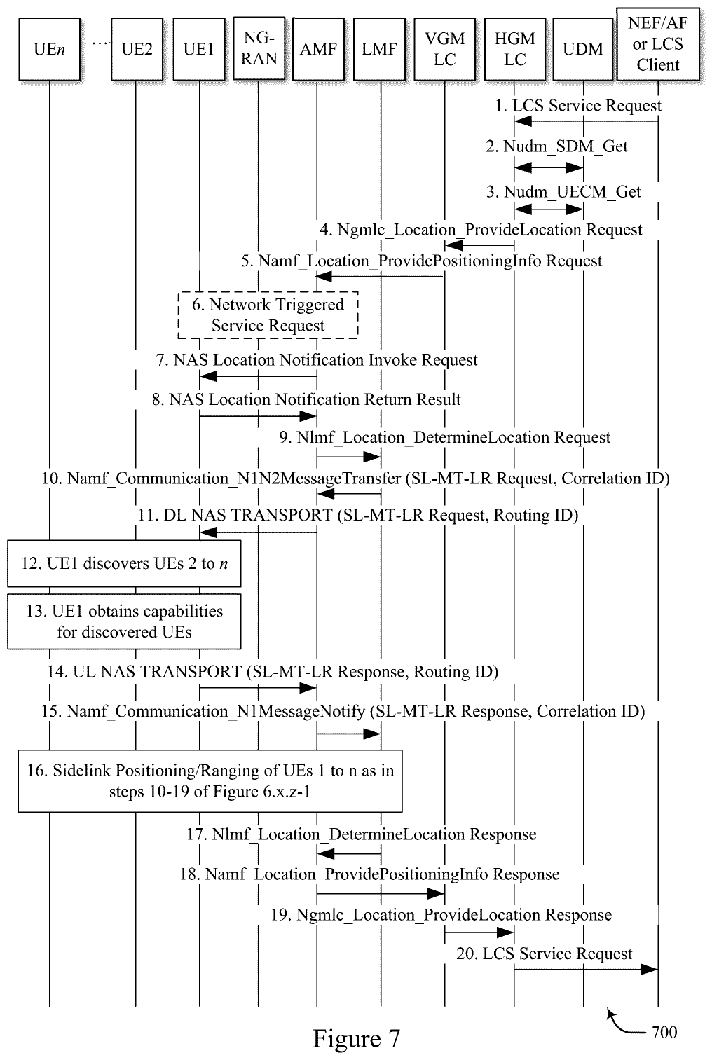

FIG. 7 illustrates a procedure 700 to enable an LCS Client or AF to obtain ranging and/or sidelink positioning location results for a group of n UEs. For instance (n≥2), e.g., UE1, UE2, . . . , UEn. In the procedure 700, the GMLC determines a UE among the n UEs to be designated UE1 (e.g., Target UE in TS 23.586) and one or more other UEs designated UE2, UE3, . . . , UEn (n≥2) (e.g., Reference/Located UEs in TS 23.586). The Ranging/Sidelink Positioning location results may include absolute locations, relative locations or ranges and directions related to the UEs, based on the service request. A SL-MT-LR procedure can be used to estimate the relative locations or distances and/or directions between the UEs. Further, an example procedure for periodic and triggered SL-MT-LR is defined in clause 6.20.4. In the procedure 700 it can be assumed that are least one of the n UE is in coverage and registered with a serving PLMN.
1. The LCS Client or the AF (via NEF) sends an LCS service request to the (H)GMLC for Ranging/Sidelink Positioning location results for the n UEs which may each be identified by a GPSI or a subscription permanent identifier (SUPI). The request may include the required QoS, the required location results (e.g. absolute locations, relative locations or distances and/or directions related to the UEs), the SL reference UE(s) in case of relative locations, distance, or direction. The (H)GMLC or NEF authorizes the LCS Client or the AF for the usage of the LCS service. If the authorization fails, the remaining steps are skipped and the (H)GMLC or NEF responds to the LCS Client or the AF with the failure of the service authorization.

In addition, an Application Layer ID shall be included for each of the n UEs to enable discovery of the UEs at step 12.
2. The (H)GMLC invokes a Nudm_SDM_Get service operation towards the Unified Data Management (UDM) of each of the n UEs to get the privacy settings of the UE identified by its GPSI or SUPI. The UDM returns the UE Privacy setting of the UE. The (H)GMLC checks the UE LCS privacy profile.
3. The (H)GMLC invokes a Nudm_UECM_Get service operation towards the UDM of each of the n UEs (for which GPSI or SUPI is available), one at a time, using the GPSI or SUPI of each UE. The (H)GMLC selects the UE (e.g. which is treated as UE1 in following steps) that initiates the Ranging/SL Positioning and selects the corresponding serving AMF.
NOTE: The UDM is aware of the serving AMF address at UE registration on an AMF as defined in clause 4.2.2.2.2 of TS 23.502. The UDM is aware of a serving (V)GMLC address at UE registration on an AMF as defined in clause 4.2.2.2.2 of TS 23.502.
4. For a non-roaming case, this step is skipped. In the case of roaming, the (H)GMLC may receive an address of a (V)GMLC (together with the network address of the current serving AMF) from the UDM in step 3, otherwise, the (H)GMLC may use the Network Repository Function (NRF) service in the (H)PLMN to select an available (V)GMLC in the (V)PLMN, based on the (V)PLMN identification contained in the AMF address received in step 3. The (H)GMLC then sends the location request to the (V)GMLC by invoking the Ngmlc_Location_ProvideLocation service operation towards the (V)GMLC. In the cases when the (H)GMLC did not receive the address of the (V)GMLC, or when the (V)GMLC address is the same as the (H)GMLC address, or when both PLMN operators agree, the (H)GMLC sends the location service request message to the serving AMF. In this case, step 4 is skipped. The (H)-GMLC also provides the LCS client type of AF, if received in step 1, or LCS client type of LCS client and other attributes to be sent to AMF in step 5.
5. In the case of roaming, the (V)GMLC first authorizes that the location request is allowed from this (H)GMLC, PLMN or from this country. If not, an error response is returned. The (H)GMLC or (V)GMLC invokes the Namf_Location_ProvidePositioningInfo service operation towards the AMF serving UE1 to request Sidelink positioning/ranging location results of the n UEs. The service operation includes the SUPI of UE1, Application layer IDs of the UEs, the client type and may include the required LCS QoS, the required location results (e.g. relative locations or ranges and directions related to the UEs) and other attributes as received or determined in step 1.
6. If UE1 is in CM-IDLE state, the AMF initiates a network triggered Service Request procedure to establish a signaling connection with UE1. If signaling connection establishment fails, steps 7-17 can be skipped.
7-8. If the indicator of privacy check indicates an action is needed, then same operation as that of step 7-8 of clause 6.1.2 is carried out.
9. The serving AMF selects an LMF serving UE1 (e.g. an LMF that supports Ranging/Sidelink Positioning) and sends an Nlmf_Location_DetermineLocation service operation towards the LMF with the information received at step 5 e.g. required location results (e.g. relative locations or ranges and directions between pairs of UEs), SL reference UE(s) in case of relative locations, Application layer IDs of the UEs if received in step 5. The service operation includes a LCS Correlation identifier.
10. The LMF sends an SL-MT-LR request to the serving AMF as a supplementary services message, using the Namf_Communication_N1N2MessageTransfer service operation, and the session ID parameter is set to the LCS Correlation identifier. The SL-MT-LR request may include the application layer IDs of the other UEs 2 to n, the types of required location results (e.g. relative locations or distances and/or directions) and SL reference UE(s) in case of relative locations.
11. The serving AMF forwards the SL-MT-LR request and a Routing identifier equal to the LCS Correlation identifier to UE1 using a DL NAS TRANSPORT message.
12. UE1 attempts to discover the other UE 2 to n using their Application Layer IDs if not already discovered using procedure defined in clause 6.4 of TS 23.586.
13. UE1 obtains the sidelink positioning capabilities of the discovered UEs via the SLPP if not already obtained.
14. UE1 returns a supplementary services SL-MT-LR response to the serving AMF in an UL NAS TRANSPORT message and includes the Routing identifier received in step 11. The SL-MT-LR response indicates which of UEs 2 to n have been discovered and the sidelink positioning capabilities of the discovered UEs.
15. The serving AMF forwards the SL-MT-LR response to the LMF indicated by the Routing identifier received at step 14 and includes a LCS Correlation identifier equal to the Routing identifier.
16. Ranging/Sidelink Positioning of UE1 and the other discovered UEs occurs as for an SL-MO-LR with the difference that Ranging/Sidelink Positioning location measurement data or results can be returned to the LMF and the LMF indicates to UE1 at step 13 or step 14 of FIG. 5 whether the Ranging/Sidelink Positioning location results will be calculated by the LMF (at step 19) or by UE1 (at step 17). For some undiscovered UEs among the other UEs 2 to n, the LMF interacts with GMLC to initiate the 5GC-MT-LR procedure for UE2 to n to get their absolute locations and calculates the relative locations or distances and/or directions related to the UEs.
17-20. The LMF returns the Sidelink positioning/ranging location results to the LCS Client or AF as in steps 13-15 and step 24 of clause 6.1.2. The results also include failure information of the UE(s) that was not discovered.

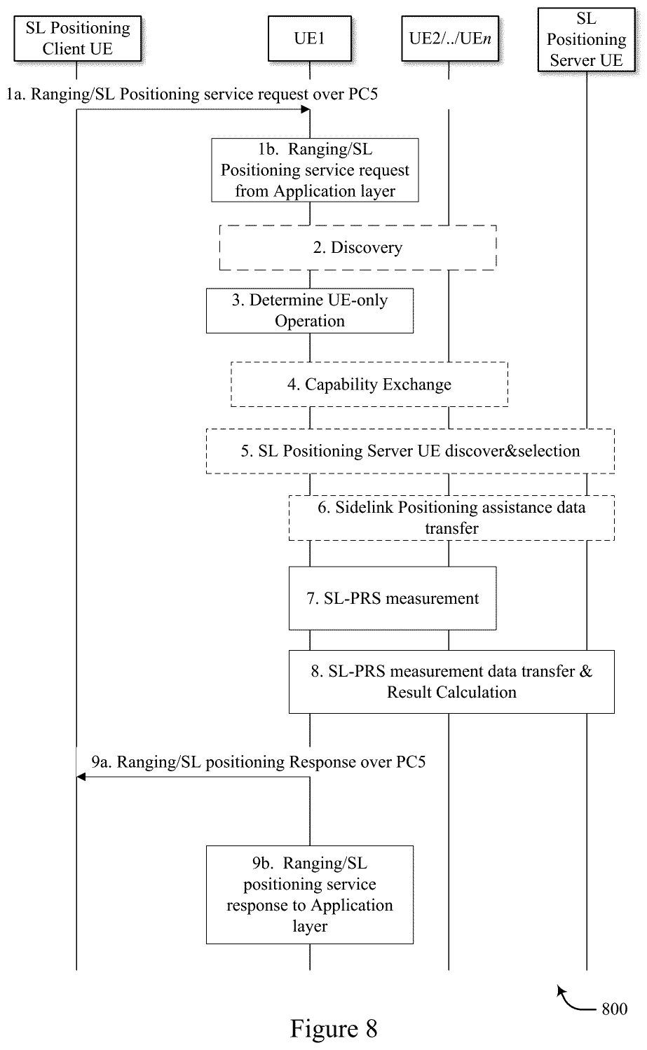

FIG. 8 illustrates an example procedure 800 for ranging and/or SL positioning control such as for UE-only operation. Either UE-only operation or network-based operation can be applied in the ranging/sidelink positioning control procedures.

For instance, UE-only operation can be applied for the following cases:
Neither Target UE nor SL Reference UE is served by NG-RAN.
Network-based Operation is not supported by the 5GC network.
When Network-based Operation is not supported by the 5GC network, indication on whether the UE is allowed to use UE-only operation to perform Ranging/SL Positioning is included in the Policy/Parameter provisioned to UE and is provisioned to the UE. The Target UE will take it into account to initiate UE-only operation procedure.
SL-MO-LR request is rejected by the network.

In the procedure 800:
1. UE1 (i.e. Target UE) may receive a Ranging/SL Positioning Service request from:
   1a. SL Positioning Client UE over PC5 during procedures for Ranging/SL Positioning service exposure though PC5.
      For absolute location, the service request includes the SL Positioning Client UE's user info and Target UE's user info and required positioning QoS.
      For relative location or ranging information, the service request includes the SL Positioning Client UE's user info, Target UE's user info, SL Reference UE's user info (UE2/ . . . /UEn) and Ranging/SL Positioning QoS information.
   1b. RSPP application layer.
      The service request includes type of the result (i.e. absolute location, relative location or ranging information) and the required QoS.
2. UE1 discovers UE2/ . . . /UEn (e.g., SL Reference UEs/Located UEs).
3. If none of UE1/ . . . /UEn are served by NG-RAN or the serving network does not support Ranging/SL Positioning, UE-only operation is applied.
4. UE1 and UE2/ . . . /UEn perform capability exchange. Step 4 may be performed during step 5 and step 6 with coordination of SL Positioning Server UE.
5. If UE1 does not support SL Positioning Server functionalities, a SL Positioning Server UE (either co-located with a SL Reference UE/Located UE or operated by a separate UE) is discovered (if not yet discovered in step 2) and selected. If a SL Positioning Server UE that is co-located with a SL Reference UE/Located UE or operated by a separate UE, UE1 discovers and selects the SL Positioning Server UE and requests SL Positioning Server UE to participate in the Ranging/Sidelink positioning.
6. Sidelink Positioning assistant data is transferred among UE1/ . . . /UEn and the SL Positioning Server UE.
7. SL-PRS measurement is performed between UE1 and UE2/ . . . /UEn and optionally also amongst UE2/ . . . /UEn.
8. SL-PRS measurement data is transferred to the SL Positioning Server UE or is transferred to UE1 if it supports SL Positioning Server functionalities to perform result calculation. Based on the type of the result received in step 1, absolute location, relative location or ranging information is calculated at the UE.
9. Ranging/SL Positioning result is transferred to:
   9a. SL Positioning Client UE over PC5 during procedures for Ranging/SL Positioning service exposure though PC5 as defined in clause 6.6.1.1;
   9b. RSPP application layer.

Accordingly, aspects of this disclosure provide for different positioning scenarios including scenarios that do not involve a location server and implementations that involve a location server. For instance, in scenarios with no location server involvement but serving gNB involvement, an NG-RAN can schedule resources for SL-PRS transmission and SL positioning data transmission. Such implementations can involve cross layer interaction between UE SLPP and RRC layers for sharing and exchange of positioning-related information to a serving gNB. The UE may be triggered by its own higher-layers (e.g., ranging, SL positioning layer, etc.) and/or receive an indication from higher-layers of another UE to initiate a process of SL positioning transmission based on the serving gNB scheduling of resources. In implementations this can be a direct interaction between UE and NG-RAN node (e.g., serving gNB) and not involve a location server (e.g., LMF) for the provision of SL positioning assistance data.

In implementations a UE may transmit information related to the UE positioning QoS or positioning QoS mapped to the standardized PC5 5G QoS Identifier (PQI) table as part of the SL positioning assistance data request to the serving gNB where the UE is requesting resources for SL-PRS transmission. The positioning QoS can be based on a sidelink SL MO-LR location service request requested by the LCS client (e.g., application) and can be based on a single UE request or multiple UE requests), such as in terms of the following metrics:
Absolute Location
   Absolute Horizontal Location Accuracy
   Absolute Vertical Location Accuracy
Relative Location
   Relative Horizontal Location Accuracy
   Relative Vertical Location Accuracy
Ranging for Distance
   Horizontal Distance Location Accuracy
   Vertical Distance Location Accuracy
Ranging for Direction
   Azimuth Angle of Arrival Direction Accuracy
   Zenith Angle of Arrival Direction Accuracy
Other mobility QoS parameters such as:
   Absolute Horizontal/Vertical Velocity
   Relative Horizontal/Vertical Velocity

In implementations a UE (e.g., group of UE) positioning QoS is mapped to a standardized PQI table, also referred to as the transport QoS of SL positioning-related messages given by the highlighted portion in Table 5 below. It can be noted that:
The PQI value can be given by ‘X’, which can be an integer value.
The resource type is non-guaranteed bit rate (GBR) as shown in Table 5 to accommodate different cast type SL-PRS and SLPP message transmissions including capability exchange, assistance data exchange, location information exchange, error and bort message exchanges. In implementations the resource type may be configured to GBR or delay critical service as SL positioning may be considered as critical sidelink services.
The Default Priority Level can be ‘Y’, which can be an integer value to reflect the default priority of SL positioning-related messages.
   In another implementation, the Default priority may assist in determining the Layer-1 priority of SL positioning related messages and/or SL-PRS.
The Packet Delay Budget (PDB) can be given by ‘Z’ ms which can be an integer value. In another implementation, the delay budget may be split up to reflect SLPP positioning related messages given by ‘Z1’ PDB and SL-PRS transmissions given by ‘Z2’ positioning/location delay budget (PoDB/LDB).
   The PDB/PoDB/LDB may be used by lower layers to convey the SL-PRS/SLPP positioning resource selection window for Mode 2 procedures. This can indicate a latency limit to by which the SLPP transport block message or SL-PRS are to be transmitted.
   The resource selection window is defined by [n+T₁, n+T₂], where n is the slot at which the resources should be selected, T₁ is defined as the processing time to identify SL-PRS/SLPP message resource candidates and select these resources for transmission, while T₂ is defined as T₂ₘᵢₙ≤T₂≤PDB.
   This PDB/PoDB/LDB may be signalled as part of the QoS profile from the UE's own higher-layers, or in other implementations received from another UE/device, via 1^{st} stage or 2^{nd} stage SCI.
The packet error rate can be given by ‘A’ to indicate the reliability of SL positioning-related messages given by block error rate (BLER), bit error rate (BER), packet error rate (PER), or any related metric.
The default maximum data burst volume is not specified for SL positioning but in other implementations a data burst volume may be given in bytes applicable to SL positioning-related messages.
The default averaging window can be given by ‘B’ ms, which can be an integer value.
NOTE that multiple sets of {X, Y, Z, A, B} may be defined as part of the standardized PQI.

In scenarios, where the standardized PQI is not available or provided, a default set of SL positioning PQIs applicable to {X, Y, Z, A, B} values may be pre-configured within a UE. In another implementation, supported PQIs {X, Y, Z, A, B} may be broadcast to UE for appropriate selection.

According to implementations Mode 2 and/or Scheme 2 can support both autonomous dynamic and semi-persistent scheduling. In a dynamic scheme, a UE can sense and select resources based on SL-PRS transmission configuration and/or SL positioning data message (e.g., transport block (TB)), while a semi-persistent scheme can select a number of consecutive resources based on a number of consecutive reselection counters applicable for SL-PRS and SL positioning data transmissions. In implementations a time period is defined between the selected resources for the transmission of consecutive SL-PRS and/or SL positioning data messages (e.g., TBs) given by the RRI (Resource Reservation Interval) with range {[1:99], 100, 200, . . . , 1000} ms.

A UE may select resources when it generates a new SL positioning TB based on a higher-layer trigger and/or when it receives a higher-layer trigger to transmit SL-PRS according to a defined SL-PRS configuration. A UE can perform sensing according to a sensing window bounded by [n−T₀, n−T_{proc,0}), where n is defined as above, T₀ is defined in terms of number of slots (also dependent on Sub-Carrier Spacing (SCS)) and T_{proc,0} is the time for completing the sensing operation. A resource selection window can be initially defined by the UE as a function of T₁, T₂ and the PDB/PoDB/LDB described above. Furthermore, T₂ can be defined as a function of T₂ₘᵢₙ, which can be based on a priority value of the SL positioning TB or SL-PRS. This priority may be based on the positioning QoS, transport QoS, or combination thereof.

Thereafter, when the selection window has been defined, the UE can identify candidate resources within the selection window. A resource exclusion algorithm can then be applied to excluded candidate resource based on defined policies and thereafter the UE may select resources from the remaining candidate resources. In implementations resources can be selected subject to a percentage of remaining available resources of the selection window being higher than a configured threshold P % for SL-PRS transmission or SL Positioning data message transmission. The configured threshold of P % can be based on a priority value of the SL positioning TB or SL-PRS, where a mapping to P % to a specific priority can be determined and provided to a sensing UE.

In implementations the above-described positioning QoS and positioning-mapped PQI (also referred to as transport QoS) may be signaled to another entity (e.g., gNB and/or location server) as part of a QoS profile applicable to a particular LCS request. This QoS profile may also be signaled along with a SL QoS Flow ID. In implementations where a location server is not involved in scheduling SL-PRS transmissions, the UE may share one or more of the above QoS profiles with a serving gNB to assist in the gNB resource allocation procedure.

TABLE 5
Illustrative example of Standardized POI with SL Positioning PQI

| | | Default | Packet | | Packet | Default Maximum | | Default | | |
|---|---|---|---|---|---|---|---|---|---|---|
| PQI | Resource | Priority | Delay | | Error | Data Burst | | Averaging | | |
| Value | Type | Level | Budget | | Rate | Volume | | Window | | Example Services |
| 21 | GBR | 3 | 20 | ms | 10⁻⁴ | N/A | | 2000 | ms | Platooning between UEs - Higher degree |
| | (NOTE 1) | | | | | | | | | of automation; Platooning between UE |
| | | | | | | | | | | and roadside unit (RSU) - Higher degree |
| | | | | | | | | | | of automation |
| 22 | | 4 | 50 | ms | 10⁻² | N/A | | 2000 | ms | Sensor sharing - higher degree of automation |
| 23 | | 3 | 100 | ms | 10⁻⁴ | N/A | | 2000 | ms | Information sharing for automated driving - |
| | | | | | | | | | | between UEs or UE and RSU - higher degree of |
| | | | | | | | | | | automation |
| 55 | Non- | 3 | 10 | ms | 10⁻⁴ | N/A | | N/A | | Cooperative lane change - higher degree |
| | GBR | | | | | | | | | of automation |
| 56 | | 6 | 20 | ms | 10⁻¹ | N/A | | N/A | | Platooning informative exchange - low degree |
| | | | | | | | | | | of automation; Platooning - information |
| | | | | | | | | | | sharing with RSU |
| X | | Y | Z | ms | A | N/A | | B | ms | SLPP - SL Positioning Messages |
| 57 | | 5 | 25 | ms | 10⁻¹ | N/A | | N/A | | Cooperative lane change - lower degree of |
| | | | | | | | | | | automation |
| 58 | | 4 | 100 | ms | 10⁻² | N/A | | N/A | | Sensor information sharing - lower degree of |
| | | | | | | | | | | automation |
| 59 | | 6 | 500 | ms | 10⁻¹ | N/A | | N/A | | Platooning - reporting to an RSU |
| 90 | Delay | 3 | 10 | ms | 10⁻⁴ | 2000 | bytes | 2000 | ms | Cooperative collision avoidance; Sensor |
| | Critical | | | | | | | | | sharing - Higher degree of automation; |
| | GBR | | | | | | | | | Video sharing - higher degree of automation |
| 91 | (NOTE 1) | 2 | 3 | ms | 10⁻⁵ | 2000 | bytes | 2000 | ms | Emergency trajectory alignment; Sensor |

sharing - Higher degree of automation
(NOTE 1):
GBR and Delay Critical GBR PQIs may be used exclusively for unicast PC5 communications.

According to implementations and considering the above positioning QoS parameters, a UE may partition a request for SL-PRS resources per positioning method. Examples of such positioning methods are described above, such as SL-TDOA (UL-like) for SL RTOA measurements, SL-TDOA (DL-like) for SL RSTD measurements, SL-RTT single-sided or double-sided for SL UE Rx-Tx time difference measurements, SL-AoA for Azimuth-AoA and/or Zenith-AoA measurements, etc. This can enable a UE to request resources according to a specified positioning method. In cases of SL MO-LR without location server involvement, the decision may be up to the target UE/device and/or anchor UE/device and the UE/devices may act as a server UE and/or are equipped with server UE capabilities. In implementations a server UE may be another UE requesting for SL-PRS resources for transmission.

In implementations a requesting UE/device may request SL-PRS transmission characteristics for a given SL positioning resource pool including but not limited to the following:
SL PRS Resource Index
   SL-PRS Resource Index ID
   SL-PRS bandwidth in terms of PRBs, subchannels, subchannel size
   SL-PRS Comb size in terms of:
      SL-PRS comb offsets and associated SL-PRS comb sizes (N)
      SL-PRS starting symbols and number of SL-PRS symbols (M)
      Start time of SL-PRS may be with respect to SFN0 or DFN0 and total SL-PRS duration given X ms.
   SL-PRS periodicity in terms of:
      Tₚₒₛ₋₁^{SL-PRS} ∈
         2^{μ}{4,5,8,10,16,20,32,40,64,80,160,320,640,1280,2560,5120,10240}slots, whereμ=0,1,2,3 according to a SL-PRS Subcarrier Spacing=15, 30, 60 and 120 kHz respectively
      Tₚₒₛ₋₂^{SL-PRS} ∈
         {100,200,300,400,500,600,700,800,900,1000,5000,10000}milisecon ds (ms)
      In another implementation the configured grant periodicity may be the union of Tₚₒₛ₋₁^{SL-PRS} and Tₚₒₛ₋₂^{SL-PRS} in order to cover multiple periodicity values.
   SL-PRS Resource ID uniquely identifies a time-frequency resource within a slot of a dedicated SL PRS resource pool that is used for SL PRS transmission and in the case of a shared resource pool with SL data transmissions uniquely identifies a time-frequency resource based on a SL PRS resource ID and a SL PRS frequency domain allocation.
   SL-PRS ID, which uniquely identifies a SL-PRS based on SL-PRS Resource ID and/or SL-PRS Resource Set ID, which may be applicable to SL-PRS transmitted across different slots.
   SL Positioning Session ID
   SL-PRS Resource Set ID
   SL BWP ID
   SL Carrier ID
   SL-PRS Repetitions
   SL-PRS muting pattern

The example SL-PRS transmission characteristics indicated above may be part of a resource index list comprising of multiple SL-PRS transmission characteristics. In other implementations, the SL-PRS transmission characteristics may include QCL information such as a QCL source, e.g., SLSS, or another SL-PRS.

In implementations a UE initiating a SL positioning session or transmitting SL-PRS to one or more peer UE (e.g., via unicast, groupcast, broadcast, etc.) can initiate a SL positioning request to a serving gNB. The SL positioning request may contain parameters related to SL positioning assistance data delivery including the SL-PRS configuration, which may include a dynamic grant, Type 1 configured grant where RRC/SLPP directly provides the configured sidelink grant for NR sidelink positioning and/or communication, and/or Type 2 configured grant where RRC/SLPP defines a periodicity of the configured sidelink grant while lower layer signaling (e.g., DCI) can signal and activate the configured sidelink grant or deactivate it, e.g., release the SL positioning resources. In implementations SLPP may trigger the lower layers such as RRC to perform NR sidelink positioning and resource request with the serving gNB, e.g., NG-RAN node.

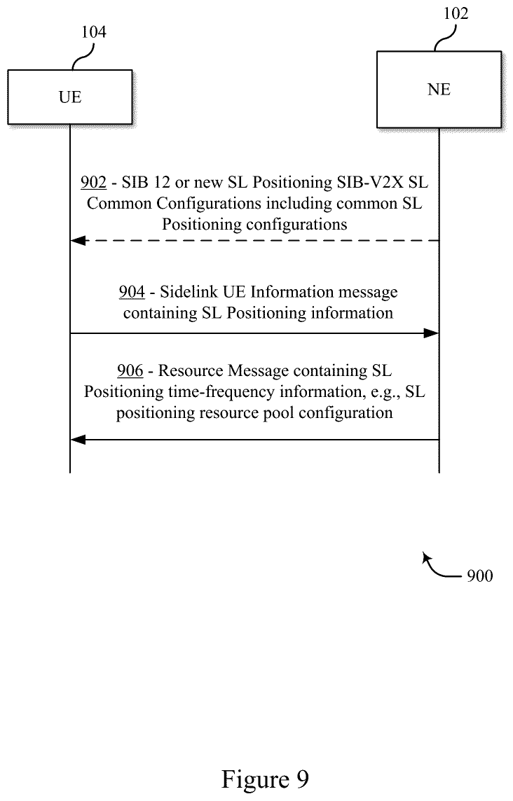

FIG. 9 illustrates an example procedure 900 for a device to initiate a request for SLPP message data exchange and/or SL-PRS transmission with the serving gNB in accordance with aspects of the present disclosure. For instance, a UE capable of SL positioning may initiate procedures to indicate its interest in transmitting or receiving SL positioning information/operation in several scenarios. Examples of such scenarios include upon successful connection establishment and/or connection resumption, upon change of transmitting or receiving SL positioning information, upon changing QoS profile(s), upon receiving UE capability information sidelink message/SLPP provide SL positioning capability information from an associated peer SL positioning UE, etc. Furthermore, a UE capable of SL positioning may initiate a procedure to request assignment of dedicated sidelink DRB configuration(s) and transmission of time-frequency resources for SL positioning reference signal and SL positioning data transmission, e.g., SLPP.

In the procedure 900 at step 902 a UE 104 may receive from a NE 102 (e.g., NG-RAN node such as a serving gNB) a system information broadcast message including SIB12 and/or a new SL positioning SIB containing the initial SL positioning common configuration information applicable to one or more UEs/devices. In implementations the UE 104 may not receive SIB 12 or the new SL Positioning SIB but may still proceed to Step 904 with the transmission of SL UE information comprising information related to the initiation of SL positioning procedures. Note that SIB 12 is used an example in the below Table 6, however, a new or equivalent SIB may be defined carrying the same information for SL positioning.

The system information broadcast message content may include the following information elements as listed in Table 6:

TABLE 6
SIB 12 or new SIB for Common SL Positioning Information

| Parameter | Description |
|---|---|
| SL Positioning Radio | Indicates one or multiple sidelink radio bearer |
| Bearer Configuration List | configurations for SL Positioning. The SL radio bearer |
| | configurations may be applicable to sidelink data radio |
| | (DRBs) bearers or other implementations, sidelink |
| | signalling radio bearers (SRBs). |
| >SL PDCP Configuration | Indicates the PDCP parameters for the sidelink DRB |
| | meant for carrying SL Positioning information. |
| >SL SDAP Configuration | Indicates how to map sidelink QoS flows to sidelink DRB |
| | meant for carrying SL Positioning information. |
| >SL Radio Bearer Index | Indicates the SL DRB configuration |
| SL Offset DFN | Indicates the timing offset for the UE to determine DFN |
| | timing when GNSS is used for timing reference. Value 1 |
| | corresponds to 0.001 milliseconds, value 2 corresponds to |
| | 0.002 milliseconds, and so on |
| SL PRS or Positioning | Indicates the priority of SL Positioning transmission |
| message Priority | and/or reception |
| SL Positioning Frequency | Indicates the SL Positioning configuration for a list of |
| Info List | carrier frequencies for transmission and reception of SL- |
| | PRS and SL positioning (SLPP) messages. |
| SL-PRS/SL positioning area | SL-PRS/SL positioning validity configuration |
| validity information | information including time-based validity criteria (e.g., |
| | timer, validity time, and so forth) and/or area-based |
| | validity criteria, e.g., zone information(e.g., zone IDs), |
| | physical cell identity (PCI), SIB area validity, Cell IDs. |
| SL Positioning | Indicates common measurement configurations (e.g. SL- |
| Measurement Common | PRS RSRP) for SL-PRS |
| Information | |

Step 904: This RRC message (e.g., sidelink UE information or similar message) can share SL positioning related information from the UE 104 with the NE 102 (such as with the serving gNB) indicating that the UE 104:
   is or is not currently configured to receive and/or transmit SL positioning messages and/or SL-PRS;
   is requesting assignment or release of transmission resource for SL positioning messages and/or SL-PRS;
   is reporting SL Positioning QoS parameters and/or associated SL transport QoS profile(s) related to SL positioning; and/or
   is reporting the sidelink positioning UE capability information of the associated peer UE for communication of all cast types.
   The message content at step 904 may include the following information elements as listed in Table 7. For purpose of illustration sidelink UE Information RRC message is used an example in the below Table. However, a new RRC message may be defined and/or another existing RRC message may be used to carry the same information containing SL Positioning-related information:

TABLE 7
Sidelink UE Information including SL Positioning-related Information

| Parameter | Description |
|---|---|
| SL Positioning Rx | Indicates the index of frequency on which the UE is |
| Interested | interested to receive SL Positioning (SLPP) messages |
| Frequency List | or SL-PRS. The value 1 corresponds to the frequency |
| | of first entry in SL Frequency Info List broadcast in |
| | SIB12, the value 2 corresponds to the frequency of |
| | second entry in SL Frequency Info List broadcast in |
| | SIB12 and so on. If SIB12 is not provided then the |
| | UE relies on the same SL Positioning Rx Interested |
| | Frequency List information received and stored via a |
| | previous sidelink UE information message or if that is |
| | not available, then relies on the pre-configuration of |
| | SL positioning interested Rx frequencies. |
| SL Positioning Rx | Indicates the reported QoS profile and associated with |
| Interested Unicast, | one or more destination/receivers for which the UE is |
| Groupcast, Broadcast | interested in reception to the network for SL unicast, |
| Destination List | groupcast and broadcast SL-PRS and SLPP/SL |
| | positioning. This destination list may contain a set of |
| | Layer-2 Destination IDs, which may be generated at |
| | the Ranging/SL positioning layer. |
| SL Positioning Source | Indicates the Source Layer-2 ID to be used to |
| Identity of Anchor or | establish a PC5 link with the respective target UE or |
| Target UE | Anchor UE. |
| SL Positioning | Parameters to request the transmission resources for |
| Transmission Resource | SL positioning or SL-PRS to the serving gNB in the |
| Request | Sidelink UE Information report |
| >SL UE Capability | Indicates the SL Positioning UE capability to the |
| Information | network. Detailed and relevant capabilities for |
| | performing SL positioning are conveyed using the SL |
| | Positioning capabilities IE under SL Positioning- |
| | related information. |
| >SL Positioning Cast | Indicates the cast type for the corresponding |
| Type | destination for which to request the resources for SL- |
| | PRS and/or SLPP messages |
| >SL Positioning | Indicates the destination for which the SL Positioning |
| Destination ID | TX resource request and allocation from the network |
| | are applicable. This destination ID may include a |
| | Layer-2 Destination ID, which may be generated at |
| | the Ranging/SL positioning layer. |
| >SL Transport QoS | Includes the QoS profile of the sidelink QoS flow as |
| Information List | shown in Error! Reference source not found., |
| | which is applicable to SL Positioning messages. |
| >SL QoS Flow ID | Uniquely identifies one sidelink QoS flow between |
| | the UE and the serving gNB, which is unique for |
| | different destination and cast type indicated above. |
| >SL RLC Mode | Indicates the RLC mode and optionally the related |
| Indications | QoS profiles for the sidelink radio data bearer, which |
| | has not been configured by the network and is |
| | initiated by another target-UE, anchor-UE or server- |
| | UE in unicast, groupcast or broadcast. The RLC |
| | mode for one sidelink radio bearer is aligned between |
| | UE and NW by the SL QoS Flow ID |
| >SL Tx Frequency | Each entry of this field indicates the index of |
| List | frequency on which the UE is interested to transmit |
| | SL-PRS and SL Positioning (SLPP) messages. The |
| | value 1 corresponds to the frequency of first entry in |
| | SL Frequency Info List broadcast in SIB12, the value |
| | 2 corresponds to the frequency of second entry in SL |
| | Frequency Info List broadcast in SIB12 and so on. If |
| | SIB12 is not provided then the UE relies on the same |
| | SL Positioning Tx Interested Frequency List |
| | information received and stored via a previous |
| | sidelink UE information message or if that is not |
| | available, then relies on the pre-configuration of SL |
| | positioning interested Tx frequencies |
| >SL Tx | A list of synchronization reference used by the |
| Synchronization | requesting UE. The requesting UE shall include the |
| List | same number of entries, listed in the same order, as in |
| | SL Tx Frequency List, i.e. one for each carrier |
| | frequency included in SL Tx Frequency List. The |
| | synchronization references may include GNSS synch |
| | source, eNB/gNB sync source, or sync reference UE |
| >SL Positioning Session | Indicates the particular SL positioning session ID for |
| ID | which the transmission resource is requested. A UE |
| | may request resources for one or more parallel SL |
| | positioning sessions. This information can be |
| | retrieved via cross layer interaction between SLPP |
| | and RRC. |
| SL Positioning | List of parameters to request the transmission |
| Transmission Resource | resources for SL positioning for the associated one or |
| Request List | more destination or responder UEs. |
| UE-type | Indicates whether the UE is acting as an Anchor UE, |
| | target UE, Server UE, Client UE, or Assistant UE. |
| SL Positioning-related | Parameters that convey SL positioning-related |
| Information | information applicable to a particular session |
| >SL Positioning | Indicates the SL Positioning capabilities of the UE |
| Capabilities | including supported positioning methods and can be |
| | retrieved via cross layer interaction between SLPP |
| | and RRC |
| >SL Positioning Methods | Indicates the SL positioning method for which the |
| | transmission resources are requested for transmission |
| | of SL-PRS. |
| >SL Positioning QoS | Indicates the associated Positioning QoS associated to |
| Information List | the transmission of resource request with the |
| | parameters detailed earlier in Embodiment 1. |
| SL Positioning | Parameters to request the transmission resources for |
| Transmission Resource | SL positioning discovery to the serving gNB in the |
| Discovery Request | Sidelink UE Information report |
| >SL Cast Type SL | Indicates the cast type for the corresponding |
| Positioning Discovery | destination for which to request the SL positioning |
| | discovery messages |
| >SL Positioning | Indicates the destination for which the SL Positioning |
| Discovery Destination ID | discovery resource request and allocation from the |
| | network are applicable. |
| >SL Positioning | Indicates the source L2 ID of SL Positioning |
| Discovery Source ID | discovery transmission by target-UE, anchor-UE, |
| | server-UE, Client UE or the like. |
| >SL Positioning Tx | Each entry of this field indicates the index of |
| Discovery Frequency | frequency on which the UE is interested to transmit |
| List | SL Positioning Discovery messages. The value 1 |
| | corresponds to the frequency of first entry in SL |
| | Frequency Info List broadcast in SIB12, the value 2 |
| | corresponds to the frequency of second entry in SL |
| | Frequency Info List broadcast in SIB12 and so on. If |
| | SIB12 is not provided then the UE relies on the same |
| | SL Positioning Tx Discovery Frequency List |
| | information received and stored via a previous |
| | sidelink UE information message or if that is not |
| | available, then relies on the pre-configuration of SL |
| | positioning interested Tx Discovery frequencies. |

Step 906: Transmission time-frequency resources from the NE 102 to the UE 104 including resource pool information (e.g., dedicated SL-PRS only resource pool, shared pool including SL-PRS and SL data) which may be provided to the UE 104 via lower layer signaling such as DCI and/or an RRC message, e.g., RRCReconfiguration and/or a separate/new SL Positioning Information message. This resource message can be a high-level resource configuration message indicating an overall set of resources to perform SL-PRS and SL positioning data message transmission applicable to a cell. This may include:
one or more SL-PRS dedicated resource pools for Mode 1/Scheme 1 transmissions and/or Mode 2/Scheme 2 transmissions;
one or more SL-PRS and SL communication data shared resource pools for Mode 1/Scheme 1 transmissions and/or Mode 2/Scheme 2 transmissions;
one or more SL positioning exceptional resource pools for exceptional transmissions including cases where the UE is transitioning from RRC_IDLE to RRC_CONNECTED state, experiences Uu Radio Link Failure, performs a handover or switches between a transmit resource pool, e.g., from a dedicated resource pool to shared resource pool, which may include SL-PRS only or SL-PRS and SL positioning data messages;
In implementations Mode 1/Scheme 1 can refer to a centralized resource allocation scheme, where the gNB manages and schedules SL transmissions, while Mode2/Scheme 2 can refer to distributed resource allocation scheme, where each UE autonomously senses and performs resource selection of desired transmission resources.

In implementations one UE may transmit sidelink UE information message on behalf of multiple UEs involved within a single SL positioning session. This can reduce the signaling overhead of each UE involved in a SL positioning session from transmitting a SL UE information message individually.

As mentioned above, implementations also include SL positioning assistance data delivery involving a location server. For instance, in scenarios involving a location server, the location server may deliver the SL-PRS (SL Positioning) assistance data such as including Mode 1 and/or Mode 2 dedicated (SL-PRS only) and/or shared/common (SL-PRS and SL data) resource pool information in a semi-static manner to a UE via LPP/SLPP signaling, e.g., upon request by the UE and/or periodically after a period of time. This may be beneficial as the location server may have multiple SL positioning data sets from multiple NG-RAN nodes however such SL positioning assistance data delivery mechanism may not be dynamic enough.

According to implementations a serving gNB (e.g., serving NG-RAN node) and/or neighboring gNBs may transmit unsolicited SL PRS configuration response messages containing requested SL-PRS transmission characteristics to a location server. In additional or alternative implementations solicited requests may be transmitted by the location server to receive the SL-PRS transmission characteristics from the NG-RAN nodes.

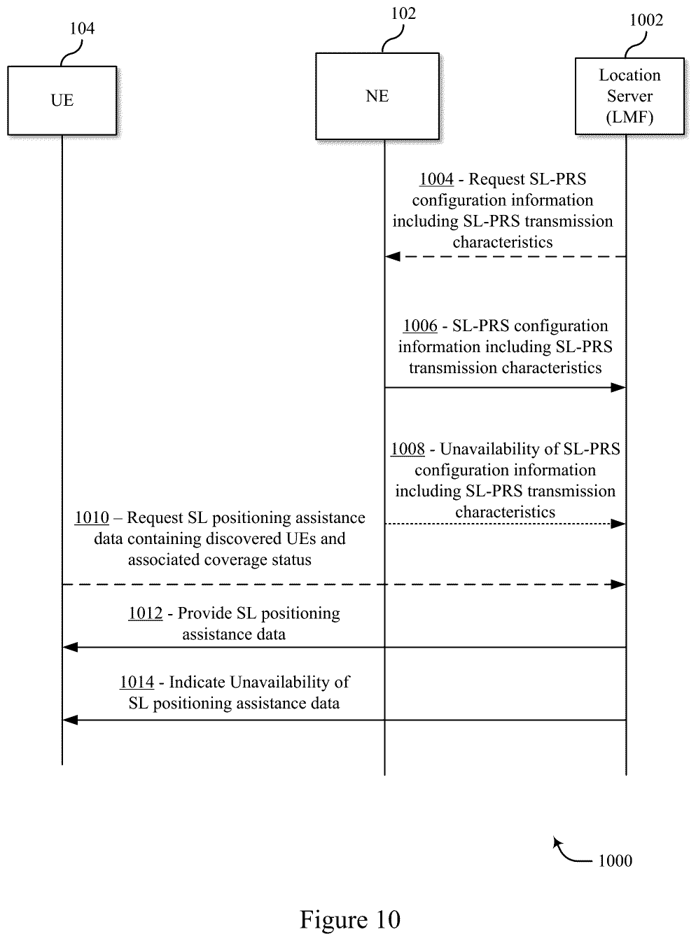

FIG. 10 illustrates an example of a procedure 1000 that supports sidelink positioning assistance in accordance with aspects of the present disclosure. The procedure 1000, for instance, provides for provision of SL-PRS semi-static configuration information by the location server to UE/device. In implementations the SL-PRS semi-static configuration consists of SL-PRS transmission characteristics, which may enable the UE to transmit SL-PRS to one or more other UEs, e.g., unicast, groupcast, or broadcast. In implementations the semi-static configuration may also apply for the transmission of SL positioning data messages, e.g., SLPP messages to one or more other UE such as via unicast, groupcast, and/or broadcast. The UE, for example, may use the semi-static configuration based on a configured validity criteria (e.g., time-based criteria, area-based criteria, etc.) associated with the one or more semi-static configurations. If the semi-static configuration is invalid, then the associated one or more semi-static configurations may also be considered invalid. In implementations the UE/device may represent a target-UE, anchor UE, server UE, a UE involved in the transmission of SL-PRS, etc.

In the procedure 1000, at step 1004 a location server 1002 (e.g., LMF) may solicit from an NE 102 (e.g., an NG-RAN node) a request for SL-PRS configuration information including SL-PRS transmission characteristics from the applicable NG-RAN node, which may be provided on periodical basis or whenever the said transmission characteristics have been updated/released. The requested SL-PRS transmission characteristics may include one or more of:
SL Positioning Dedicated Resource Pool ID for Mode/Scheme 1 or Mode/Scheme 2 SL-PRS or SL positioning transmissions;
SL Positioning Shared Resource Pool ID for Mode/Scheme 1 or Mode/Scheme 2 SL-PRS or SL positioning transmissions;
A SL-PRS Resource Index ID comprising the following may also be shared with the location server from the NG-RAN node (In implementations the NG-RAN node can receive this information from the UE in the case of SL MO-LR or SL UE-based positioning):
   SL-PRS bandwidth in terms of PRBs, subchannels, subchannel size;
   SL-PRS Comb size in terms of:
      SL-PRS comb offsets and associated SL-PRS comb sizes (N);
      SL-PRS starting symbols and number of SL-PRS symbols (M);
      Start time of SL-PRS may be with respect to SFN0 or DFN0 and total SL-PRS duration given X ms.;
   SL-PRS periodicity in terms of:
      Tₚₒₛ₋₂^{SL-PRS} ∈
         2^{μ}{4, 5, 8, 10, 16, 20, 32, 40, 64, 80, 160, 320, 640, 1280, 2560, 5120, 10240} slots, whereμ=0, 1, 2, 3 according to a SL-PRS Subcarrier Spacing=15, 30, 60 and 120 kHz respectively;
      Tₚₒₛ₋₂^{SL-PRS} ∈
         {100, 200, 300, 400, 500, 600, 700, 800, 900, 1000, 5000, 10000} milisecon ds (ms);
      In implementations the configured grant periodicity may be the union of Tₚₒₛ₋₁^{SL-PRS} and Tₚₒₛ₋₂^{SL-PRS} to over multiple periodicity values.
   A SL-PRS resource ID can identify a time-frequency resource within a slot of a dedicated SL PRS resource pool that is used for SL PRS transmission and in scenarios involving a shared resource pool with SL data transmissions, identify a time-frequency resource based on a SL PRS resource ID and a SL PRS frequency domain allocation.
   SL-PRS ID, which uniquely identifies a SL-PRS based on SL-PRS Resource ID and/or SL-PRS Resource Set ID;
   SL Positioning Session ID;
   SL-PRS Resource Set ID;
   SL BWP ID;
   SL Carrier ID;
   SL-PRS Repetitions; and/or
   SL-PRS muting pattern.
Validity time associated with the above SL-PRS transmission characteristics, based on a start timer and duration or an expiry timer. In implementations the validity of the semi-static SL PRS configurations may be associated with an area validity, e.g., the SL-PRS configurations are only valid in certain zones with zone IDs, cells, TRPs, PCI, CGI, TAI, RAN notification areas, and/or combinations thereof.
Example signaling may include NRPPa signaling and associated messaging.

At step 1006 the NE 102 may respond with one or more of the SL-PRS configuration information including SL-PRS transmission characteristics. Example signaling may include NRPPa signaling and associated messaging. At step 1008 such as in the event of the unavailability of one or more of the SL-PRS configuration information including SL-PRS transmission characteristics, the NE 102 may indicate this accordingly. Example signaling may include NRPPa signaling and associated messaging.

At step 1010 and based at least in part on a type of positioning being performed (e.g., SL MO-LR and/or SL UE-based positioning) the UE 104 may request semi-static SL positioning assistance data. The request for semi-static SL positioning assistance data configuration may include SL-PRS transmission characteristics and/or SL positioning data message resources. In implementations the semi-static SL positioning assistance data may override preconfigured SL positioning assistance data. Further, the UE 104 may first utilize the semi-static SL positioning assistance data configuration before previously stored and/or pre-configured semi-static SL positioning assistance data configuration. Example signaling may include SLPP/LPP signaling and associated messaging.

At step 1012 the location server 1002 may signal the SL positioning assistance data including the SL-PRS semi-static transmission characteristics to the UE 104 using UE-specific signaling such as LPP/SLPP or broadcast signaling via positioning SIBs. Example signaling may include SLPP/LPP signaling and associated messaging. At 1014 the location server 1002 may signal the unavailability of the requested SL-PRS semi-static transmission characteristics to the UE 104 using UE-specific signaling such as LPP/SLPP. In implementations steps 1006, 1008, 1012, and/or 1014 may be transmitted in an unsolicited manner. Example signaling may include SLPP/LPP signaling and associated messaging.

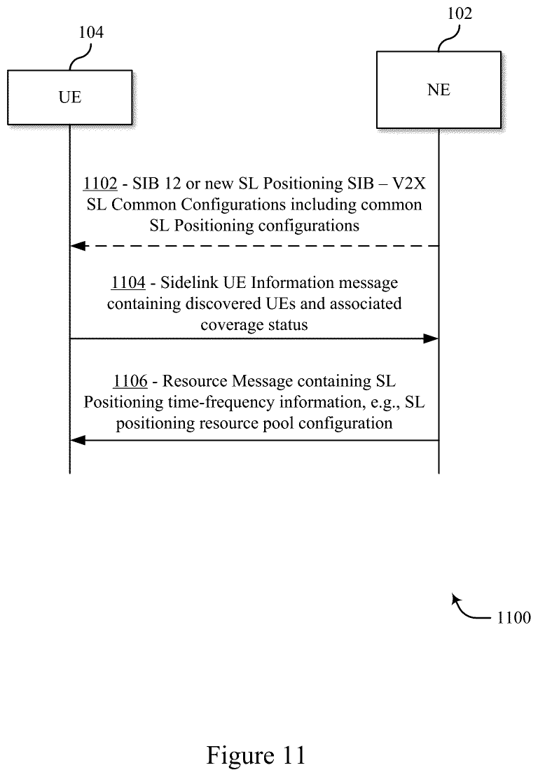

FIG. 11 illustrates an example of a procedure 1100 that supports sidelink positioning assistance in accordance with aspects of the present disclosure. The procedure 1100, for instance, provides for discovered Ues for SL positioning and associated coverage status without location server involvement. At step 1102 a NE 102 (e.g., an NG-RAN node such as a serving gNB) may transmit to a UE 104 SIB 12 and/or new SL positioning SIB=V2X SL Common Configurations including common SL Positioning configurations. At step 1104 the UE 104 may transmit to the NE 102 a sidelink UE information message including discovered Ues and associated coverage status. At step 1106 the NE 102 may transmit to the UE 104 a resource message including SL positioning time-frequency information, e.g., a SL positioning resource pool configuration.

In the procedure 1100 such as in scenarios where a location server is involved, a request for SL positioning assistance data may convey information about already discovered Ues and their associated coverage status. The steps may be similar to the procedure 1000Error!Reference source not found, except that in at least some implementations the request for SL positioning assistance data can include the following information:
List of Discovered Ues consisting of:
   UE-type: Anchor-UE (with or without known location information), Server UE, Client UE, Assistant UE;
   UE ID such as 5G TMSI (when in-coverage), layer 2 source-ID, layer-2 destination-ID, group IDs and associated member IDs;
   Coverage status indication using a flag or choice variable comprising of in-coverage or out-of-coverage;
SL Positioning QoS information.

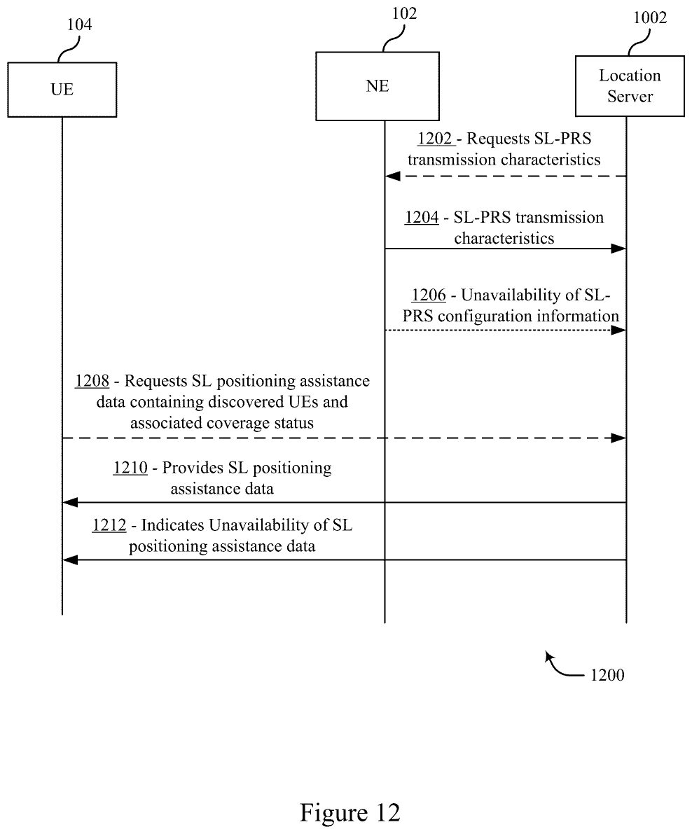

FIG. 12 illustrates an example of a procedure 1200 that supports sidelink positioning assistance in accordance with aspects of the present disclosure. The procedure 1200, for instance, provides for discovered UE for SL positioning and associated coverage status with location server involvement. At step 1202 a location server 1002 (e.g., LMF) can transmit to a NE 102 (e.g., an NG-RAN node) a request for SL-PRS transmission characteristics. At step 1204 the NE 102 can transmit SL-PRS transmission characteristics to the location server 1002. At step 1206 and optionally the NE 102 can transmit to the location server 1002 an indication of unavailability of SL-PRS configuration information.

At 1208 the UE 104 can optionally transmit to the location server 1002 a request for SL positioning assistance data including discovered UEs and associated coverage status. At 1210 the location server 1002 can transmit to the UE 104 SL positioning assistance data and at 1212 the location server 1002 can transmit to the UE 104 an indication of the unavailability of SL positioning assistance data.

According to implementations the UE 104 in the procedures 1100, 1200 may have already received coverage status of discovered UEs via various signaling mechanisms including lower layer signaling such as 1^{st} or 2^{nd} stage SCI, SL MAC CE and/or higher-layer signaling such as PC5 RRC, SLPP, PC5-S and so forth. A request for the coverage status may also be based on solicited on unsolicited messages.

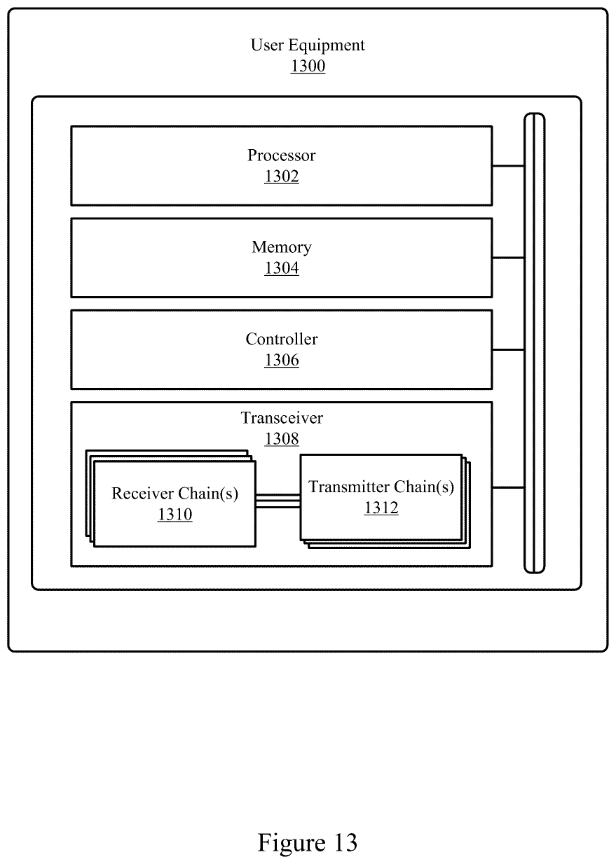

FIG. 13 illustrates an example of a UE 1300 in accordance with aspects of the present disclosure. The UE 1300 may include a processor 1302, a memory 1304, a controller 1306, and a transceiver 1308. The processor 1302, the memory 1304, the controller 1306, or the transceiver 1308, or various combinations thereof or various components thereof may be examples of means for performing various aspects of the present disclosure as described herein. These components may be coupled (e.g., operatively, communicatively, functionally, electronically, electrically) via one or more interfaces.

The processor 1302, the memory 1304, the controller 1306, or the transceiver 1308, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1302 may include an intelligent hardware device (e.g., a general-purpose processor, a DSP, a CPU, an ASIC, an FPGA, or any combination thereof). In some implementations, the processor 1302 may be configured to operate the memory 1304. In some other implementations, the memory 1304 may be integrated into the processor 1302. The processor 1302 may be configured to execute computer-readable instructions stored in the memory 1304 to cause the UE 1300 to perform various functions of the present disclosure.

The memory 1304 may include volatile or non-volatile memory. The memory 1304 may store computer-readable, computer-executable code including instructions when executed by the processor 1302 cause the UE 1300 to perform various functions described herein. The code may be stored in a non-transitory computer-readable medium such as the memory 1304 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1302 and the memory 1304 coupled with the processor 1302 may be configured to cause the UE 1300 to perform one or more of the functions described herein (e.g., executing, by the processor 1302, instructions stored in the memory 1304). For example, the processor 1302 may support wireless communication at the UE 1300 in accordance with examples as disclosed herein. The UE 1300 may be configured to or operable to support a means for transmitting, from the UE to a second apparatus, a configuration message including an indication to perform one or more of sidelink positioning reference signal (SL-PRS) or SL positioning data message transmission, the configuration message including one or more SL positioning parameters; and receiving, from the second apparatus, a resource configuration message including a set of time-frequency resources in which to perform the one or more of the SL-PRS or SL positioning data message transmission.

Additionally, the UE 1300 may be configured to support any one or combination of receiving a higher-layer trigger to perform the one or more of the SL-PRS or SL positioning data message transmission; the higher-layer trigger includes one or more of sidelink positioning protocol (SLPP) layer, vehicle to everything (V2X) layer, ProSe layer, ranging layer, SL positioning layer, or sidelink positioning application layer; receiving the higher-layer trigger from a UE via one or more of: higher-layer signaling including one or more of sidelink positioning protocol layer (SLPP), PC5 radio resource control (RRC), or PC5-S; or lower layer signaling including one or more of first stage sidelink control information (SCI), first stage medium access control (MAC) control element (CE), second stage SCI, or second stage MAC CE; the configuration message includes one or more of a SL positioning QoS profile, at least one transport QoS profile indicating SL positioning transport QoS parameters, a SL positioning session identifier, SL-PRS transmission characteristics, or one or more UE discovered for SL positioning.

Additionally, the UE 1300 may be configured to support any one or combination of receiving a system information message including one or more common SL positioning configurations, the one or more common SL positioning configurations including at least one of a SL positioning radio bearer configuration list, SL-PRS priority, positioning message priority, SL positioning frequency information list, SL-PRS/SL positioning area validity information or SL positioning measurement common information; the UE includes one or more of a target UE, an anchor UE, a server UE, or an apparatus configured to perform one or more of SL-PRS or SL positioning data message transmission; the configuration message includes one or more of: a SL positioning transmission resource request; at least one of a SL positioning receiver unicast, groupcast, or broadcast destination list; one or more of a SL positioning transmitter or receiver frequency list; SL positioning UE type; one or more SL positioning capabilities; a SL positioning transmission resource discovery request; a SL positioning destination identifier; a SL positioning cast type; or a coverage status of a discovered UE; the configuration message includes one or more of SL-PRS dedicated shared pools for at least one of mode 1 and Scheme 1 transmission or mode 2 and scheme 2 transmission; the configuration message includes one or more SL-PRS and SL communication data dedicated resource pools for at least one of mode 1 and Scheme 1 transmission or mode 2 and scheme 2 transmission; the configuration message includes a coverage status indication of a set of discovered UE, and wherein the coverage status indication includes whether each discovered UE is in coverage or out of coverage.

Additionally, or alternatively, the UE 1300 may support to transmit, from the UE to a NE, a configuration message including an indication to perform one or more of sidelink positioning reference signal (SL-PRS) or SL positioning data message transmission, the configuration message including one or more SL positioning parameters; and receive, from the second apparatus, a resource configuration message including a set of time-frequency resources in which to perform the one or more of the SL-PRS or SL positioning data message transmission.

Additionally, the UE 1300 may be configured to support any one or combination of where the UE receives a higher-layer trigger to perform the one or more of the SL-PRS or SL positioning data message transmission; the higher-layer trigger includes one or more of sidelink positioning protocol (SLPP) layer, vehicle to everything (V2X) layer, ProSe layer, ranging layer, SL positioning layer, or sidelink positioning application layer; the UE receives the higher-layer trigger from another UE via one or more of: higher-layer signaling including one or more of sidelink positioning protocol layer (SLPP), PC5 radio resource control (RRC), or PC5-S; or lower layer signaling including one or more of first stage sidelink control information (SCI), first stage medium access control (MAC) control element (CE), second stage SCI, or second stage MAC CE; the configuration message includes one or more of a SL positioning QoS profile, at least one transport QoS profile indicating SL positioning transport QoS parameters, a SL positioning session identifier, SL-PRS transmission characteristics, or one or more UE discovered for SL positioning

Additionally, the UE 1300 may be configured to support any one or combination of where the UE receives a system information message including one or more common SL positioning configurations, the one or more common SL positioning configurations including at least one of a SL positioning radio bearer configuration list, SL-PRS priority, positioning message priority, SL positioning frequency information list, SL-PRS/SL positioning area validity information or SL positioning measurement common information; the UE includes one or more of a target UE, an anchor UE, a server UE, or an apparatus configured to perform one or more of SL-PRS or SL positioning data message transmission; the configuration message includes one or more of: a SL positioning transmission resource request; at least one of a SL positioning receiver unicast, groupcast, or broadcast destination list; one or more of a SL positioning transmitter or receiver frequency list; SL positioning UE type; one or more SL positioning capabilities; a SL positioning transmission resource discovery request; a SL positioning destination identifier; a SL positioning cast type; or a coverage status of a discovered UE; the configuration message includes one or more of SL-PRS dedicated shared pools for at least one of mode 1 and Scheme 1 transmission or mode 2 and scheme 2 transmission; the configuration message includes one or more SL-PRS and SL communication data dedicated resource pools for at least one of mode 1 and Scheme 1 transmission or mode 2 and scheme 2 transmission; the configuration message includes a coverage status indication of a set of discovered UE, and wherein the coverage status indication includes whether each discovered UE is in coverage or out of coverage.

The controller 1306 may manage input and output signals for the UE 1300. The controller 1306 may also manage peripherals not integrated into the UE 1300. In some implementations, the controller 1306 may utilize an operating system such as iOS®, ANDROID®, WINDOWS®, or other operating systems. In some implementations, the controller 1306 may be implemented as part of the processor 1302.

In some implementations, the UE 1300 may include at least one transceiver 1308. In some other implementations, the UE 1300 may have more than one transceiver 1308. The transceiver 1308 may represent a wireless transceiver. The transceiver 1308 may include one or more receiver chains 1310, one or more transmitter chains 1312, or a combination thereof.

A receiver chain 1310 may be configured to receive signals (e.g., control information, data, packets) over a wireless medium. For example, the receiver chain 1310 may include one or more antennas to receive a signal over the air or wireless medium. The receiver chain 1310 may include at least one amplifier (e.g., a low-noise amplifier (LNA)) configured to amplify the received signal. The receiver chain 1310 may include at least one demodulator configured to demodulate the receive signal and obtain the transmitted data by reversing the modulation technique applied during transmission of the signal. The receiver chain 1310 may include at least one decoder for decoding the demodulated signal to receive the transmitted data.

A transmitter chain 1312 may be configured to generate and transmit signals (e.g., control information, data, packets). The transmitter chain 1312 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1312 may also include at least one power amplifier configured to amplify the modulated signal to an appropriate power level suitable for transmission over the wireless medium. The transmitter chain 1312 may also include one or more antennas for transmitting the amplified signal into the air or wireless medium.

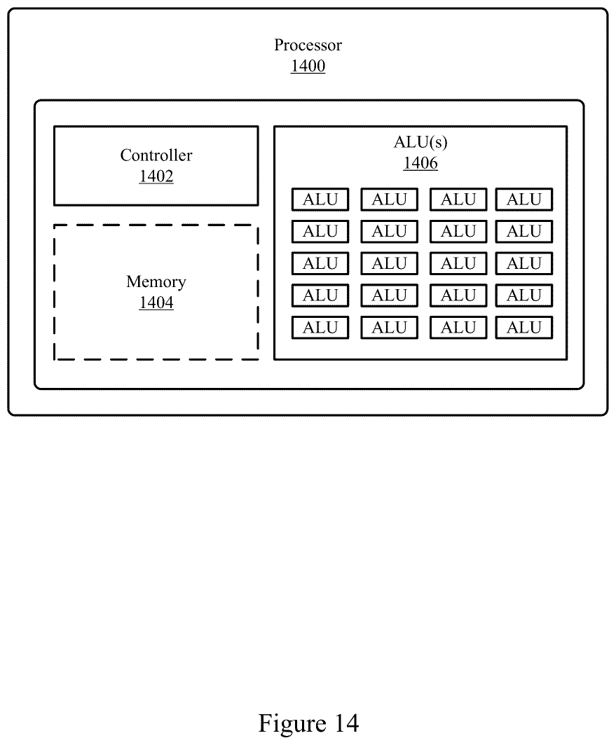

FIG. 14 illustrates an example of a processor 1400 in accordance with aspects of the present disclosure. The processor 1400 may be an example of a processor configured to perform various operations in accordance with examples as described herein. The processor 1400 may include a controller 1402 configured to perform various operations in accordance with examples as described herein. The processor 1400 may optionally include at least one memory 1404, which may be, for example, an L1/L2/L3 cache. Additionally, or alternatively, the processor 1400 may optionally include one or more arithmetic-logic units (ALUs) 1406. One or more of these components may be in electronic communication or otherwise coupled (e.g., operatively, communicatively, functionally, electronically, electrically) via one or more interfaces (e.g., buses).

The processor 1400 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 1400) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 1402 may be configured to manage and coordinate various operations (e.g., signaling, receiving, obtaining, retrieving, transmitting, outputting, forwarding, storing, determining, identifying, accessing, writing, reading) of the processor 1400 to cause the processor 1400 to support various operations in accordance with examples as described herein. For example, the controller 1402 may operate as a control unit of the processor 1400, generating control signals that manage the operation of various components of the processor 1400. These control signals include enabling or disabling functional units, selecting data paths, initiating memory access, and coordinating timing of operations.

The controller 1402 may be configured to fetch (e.g., obtain, retrieve, receive) instructions from the memory 1404 and determine subsequent instruction(s) to be executed to cause the processor 1400 to support various operations in accordance with examples as described herein. The controller 1402 may be configured to track memory addresses of instructions associated with the memory 1404. The controller 1402 may be configured to decode instructions to determine the operation to be performed and the operands involved. For example, the controller 1402 may be configured to interpret the instruction and determine control signals to be output to other components of the processor 1400 to cause the processor 1400 to support various operations in accordance with examples as described herein. Additionally, or alternatively, the controller 1402 may be configured to manage flow of data within the processor 1400. The controller 1402 may be configured to control transfer of data between registers, ALUs 1406, and other functional units of the processor 1400.

The memory 1404 may include one or more caches (e.g., memory local to or included in the processor 1400 or other memory, such as RAM, ROM, DRAM, SDRAM, SRAM, MRAM, flash memory, etc. In some implementations, the memory 1404 may reside within or on a processor chipset (e.g., local to the processor 1400). In some other implementations, the memory 1404 may reside external to the processor chipset (e.g., remote to the processor 1400).

The memory 1404 may store computer-readable, computer-executable code including instructions that, when executed by the processor 1400, cause the processor 1400 to perform various functions described herein. The code may be stored in a non-transitory computer-readable medium such as system memory or another type of memory. The controller 1402 and/or the processor 1400 may be configured to execute computer-readable instructions stored in the memory 1404 to cause the processor 1400 to perform various functions. For example, the processor 1400 and/or the controller 1402 may be coupled with or to the memory 1404, the processor 1400, and the controller 1402, and may be configured to perform various functions described herein. In some examples, the processor 1400 may include multiple processors and the memory 1404 may include multiple memories. One or more of the multiple processors may be coupled with one or more of the multiple memories, which may, individually or collectively, be configured to perform various functions herein.

The one or more ALUs 1406 may be configured to support various operations in accordance with examples as described herein. In some implementations, the one or more ALUs 1406 may reside within or on a processor chipset (e.g., the processor 1400). In some other implementations, the one or more ALUs 1406 may reside external to the processor chipset (e.g., the processor 1400). One or more ALUs 1406 may perform one or more computations such as addition, subtraction, multiplication, and division on data. For example, one or more ALUs 1406 may receive input operands and an operation code, which determines an operation to be executed. One or more ALUs 1406 may be configured with a variety of logical and arithmetic circuits, including adders, subtractors, shifters, and logic gates, to process and manipulate the data according to the operation. Additionally, or alternatively, the one or more ALUs 1406 may support logical operations such as AND, OR, exclusive-OR (XOR), not-OR (NOR), and not-AND (NAND), enabling the one or more ALUs 1406 to handle conditional operations, comparisons, and bitwise operations.

The processor 1400 may support wireless communication in accordance with examples as disclosed herein. The processor 1400 may be configured to or operable to transmit, from a first apparatus to a second apparatus, a configuration message including an indication to perform one or more of sidelink positioning reference signal (SL-PRS) or SL positioning data message transmission, the configuration message including one or more SL positioning parameters; and receive, from the second apparatus, a resource configuration message including a set of time-frequency resources in which to perform the one or more of the SL-PRS or SL positioning data message transmission.

Additionally, the processor 1400 may be configured to support any one or combination of to receive a higher-layer trigger to perform the one or more of the SL-PRS or SL positioning data message transmission; the higher-layer trigger includes one or more of sidelink positioning protocol (SLPP) layer, vehicle to everything (V2X) layer, ProSe layer, ranging layer, SL positioning layer, or sidelink positioning application layer; the at least one controller is configured to cause the processor to receive the higher-layer trigger from a UE via one or more of: higher-layer signaling including one or more of sidelink positioning protocol layer (SLPP), PC5 radio resource control (RRC), or PC5-S; or lower layer signaling including one or more of first stage sidelink control information (SCI), first stage medium access control (MAC) control element (CE), second stage SCI, or second stage MAC CE; the configuration message includes one or more of a SL positioning QoS profile, at least one transport QoS profile indicating SL positioning transport QoS parameters, a SL positioning session identifier, SL-PRS transmission characteristics, or one or more UE discovered for SL positioning; receive a system information message including one or more common SL positioning configurations, the one or more common SL positioning configurations including at least one of a SL positioning radio bearer configuration list, SL-PRS priority, positioning message priority, SL positioning frequency information list, SL-PRS/SL positioning area validity information or SL positioning measurement common information.

Additionally, the processor 1400 may be configured to support any one or combination of where the first apparatus includes one or more of a target UE, an anchor UE, a server UE, or an apparatus configured to perform one or more of SL-PRS or SL positioning data message transmission; the configuration message includes one or more of: a SL positioning transmission resource request; at least one of a SL positioning receiver unicast, groupcast, or broadcast destination list; one or more of a SL positioning transmitter or receiver frequency list; SL positioning UE type; one or more SL positioning capabilities; a SL positioning transmission resource discovery request; a SL positioning destination identifier; a SL positioning cast type; or a coverage status of a discovered UE; the configuration message includes one or more of SL-PRS dedicated shared pools for at least one of mode 1 and Scheme 1 transmission or mode 2 and scheme 2 transmission; the configuration message includes one or more SL-PRS and SL communication data dedicated resource pools for at least one of mode 1 and Scheme 1 transmission or mode 2 and scheme 2 transmission; the configuration message includes a coverage status indication of a set of discovered UE, and wherein the coverage status indication includes whether each discovered UE is in coverage or out of coverage.

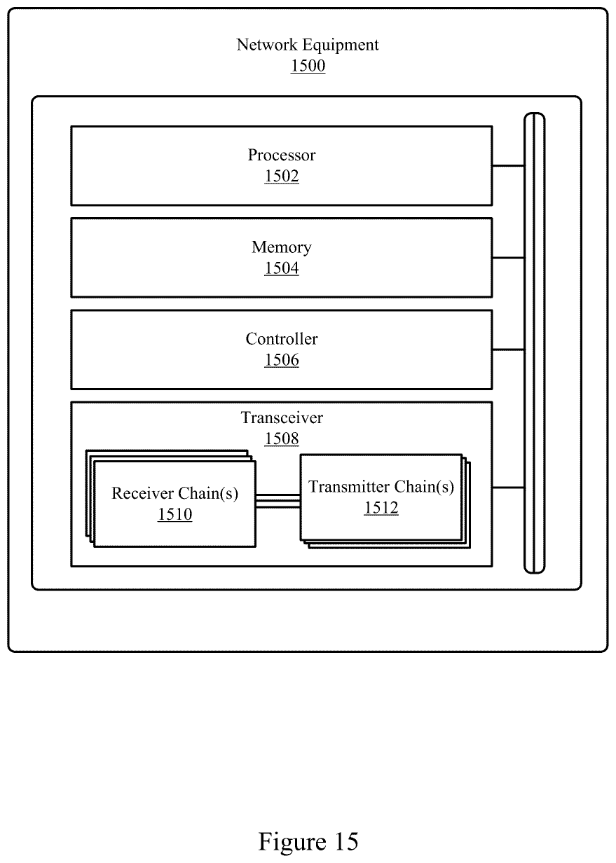

FIG. 15 illustrates an example of a NE 1500 in accordance with aspects of the present disclosure. The NE 1500 may include a processor 1502, a memory 1504, a controller 1506, and a transceiver 1508. The processor 1502, the memory 1504, the controller 1506, or the transceiver 1508, or various combinations thereof or various components thereof may be examples of means for performing various aspects of the present disclosure as described herein. These components may be coupled (e.g., operatively, communicatively, functionally, electronically, electrically) via one or more interfaces.

The processor 1502, the memory 1504, the controller 1506, or the transceiver 1508, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1502 may include an intelligent hardware device (e.g., a general-purpose processor, a DSP, a CPU, an ASIC, an FPGA, or any combination thereof). In some implementations, the processor 1502 may be configured to operate the memory 1504. In some other implementations, the memory 1504 may be integrated into the processor 1502. The processor 1502 may be configured to execute computer-readable instructions stored in the memory 1504 to cause the NE 1500 to perform various functions of the present disclosure.

The memory 1504 may include volatile or non-volatile memory. The memory 1504 may store computer-readable, computer-executable code including instructions when executed by the processor 1502 cause the NE 1500 to perform various functions described herein. The code may be stored in a non-transitory computer-readable medium such as the memory 1504 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1502 and the memory 1504 coupled with the processor 1502 may be configured to cause the NE 1500 to perform one or more of the functions described herein (e.g., executing, by the processor 1502, instructions stored in the memory 1504). For example, the processor 1502 may support wireless communication at the NE 1500 in accordance with examples as disclosed herein.

The NE 1500 may be configured to or operable to support a means for receiving, at the NE and from a UE, a configuration message including an indication to perform one or more of sidelink positioning reference signal (SL-PRS) or SL positioning data message transmission, the configuration message including one or more SL positioning parameters; and transmitting, to the UE, a resource configuration message including a set of time-frequency resources in which to perform the one or more of the SL-PRS or SL positioning data message transmission

Additionally, the NE 1500 may be configured to support any one or combination of transmitting a system information message including one or more common SL positioning configurations; the one or more common SL positioning configurations include at least one of a SL positioning radio bearer configuration list, SL-PRS priority, positioning message priority, SL positioning frequency information list, SL-PRS/SL positioning area validity information or SL positioning measurement common information.

The NE 1500 may be configured to or operable to support a means for generating, at a NE, a semi-static configuration of one or more sidelink positioning reference signal (SL-PRS) transmission characteristics including one or more SL positioning or shared resource pools; and transmitting the semi-static configuration to a UE.

Additionally, the NE 1500 may be configured to support any one or combination of where the semi-static configuration is associated with one or more of a validity time or a validity area; transmitting the semi-static configuration as one or more of a solicited message or an unsolicited message; transmitting, to the UE, an indication of unavailability of SL positioning semi-static configuration; the SL-PRS transmission characteristics include one or more of: SL positioning dedicated resource pool identifier for one or more of Mode 1 or Scheme 1 SL-PRS transmission; SL positioning dedicated resource pool identifier for one or more of Mode 1 or Scheme 1 SL positioning transmission; SL positioning dedicated resource pool identifier for one or more of Mode 2 or Scheme 2 SL-PRS transmission; SL positioning dedicated resource pool identifier for one or more of Mode 2 or Scheme 2 SL positioning transmission; SL positioning shared resource pool identifier for one or more of Mode 1 or Scheme 1 SL-PRS positioning transmission; SL positioning shared resource pool identifier for one or more of Mode 1 or Scheme 1 SL positioning transmission; SL positioning shared resource pool identifier for one or more of Mode 2 or Scheme 2 SL-PRS positioning transmission; SL positioning shared resource pool identifier for one or more of Mode 2 or Scheme 2 SL positioning transmission; or SL-PRS resource index including one or more of SL-PRS bandwidth, SL-PRS comb size, SL-PRS periodicity, SL-PRS resource identifier, SL-PRS identifier, SL positioning session identifier, SL bandwidth part (BWP) identifier, SL carrier identifier, or SL-PRS repetitions.

Additionally, the NE 1500 may be configured to support any one or combination of transmitting the semi-static configuration via one or more of UE specific signaling or broadcast signaling; one or more of: activating the semi-static configuration via one or more of UE specific signaling or broadcast signaling; or deactivating the semi-static configuration via one or more of UE specific signaling or broadcast signaling.

Additionally, or alternatively, the NE 1500 may support to receive, at an NE from a second apparatus, a configuration message including an indication to perform one or more of sidelink positioning reference signal (SL-PRS) or SL positioning data message transmission, the configuration message including one or more SL positioning parameters; and transmit, to the second apparatus, a resource configuration message including a set of time-frequency resources in which to perform the one or more of the SL-PRS or SL positioning data message transmission.

Additionally, the NE 1500 may be configured to support any one or combination of where the NE transmits a system information message including one or more common SL positioning configuration; the one or more common SL positioning configurations include at least one of a SL positioning radio bearer configuration list, SL-PRS priority, positioning message priority, SL positioning frequency information list, SL-PRS/SL positioning area validity information or SL positioning measurement common information.

Additionally, or alternatively, the NE 1500 may support to generate a semi-static configuration of one or more sidelink positioning reference signal (SL-PRS) transmission characteristics including one or more SL positioning or shared resource pools; and transmit the semi-static configuration to a UE.

Additionally, the NE 1500 may be configured to support any one or combination of where the semi-static configuration is associated with one or more of a validity time or a validity area; the NE transmits the semi-static configuration as one or more of a solicited message or an unsolicited message; the NE transmits, to the UE, an indication of unavailability of SL positioning semi-static configuration; the SL-PRS transmission characteristics include one or more of: SL positioning dedicated resource pool identifier for one or more of Mode 1 or Scheme 1 SL-PRS transmission; SL positioning dedicated resource pool identifier for one or more of Mode 1 or Scheme 1 SL positioning transmission; SL positioning dedicated resource pool identifier for one or more of Mode 2 or Scheme 2 SL-PRS transmission; SL positioning dedicated resource pool identifier for one or more of Mode 2 or Scheme 2 SL positioning transmission; SL positioning shared resource pool identifier for one or more of Mode 1 or Scheme 1 SL-PRS positioning transmission; SL positioning shared resource pool identifier for one or more of Mode 1 or Scheme 1 SL positioning transmission; SL positioning shared resource pool identifier for one or more of Mode 2 or Scheme 2 SL-PRS positioning transmission; SL positioning shared resource pool identifier for one or more of Mode 2 or Scheme 2 SL positioning transmission; or SL-PRS resource index including one or more of SL-PRS bandwidth, SL-PRS comb size, SL-PRS periodicity, SL-PRS resource identifier, SL-PRS identifier, SL positioning session identifier, SL bandwidth part (BWP) identifier, SL carrier identifier, or SL-PRS repetitions;

Additionally, the NE 1500 may be configured to support any one or combination of where the NE transmits the semi-static configuration via one or more of UE specific signaling or broadcast signaling; the NE activates the semi-static configuration via one or more of UE specific signaling or broadcast signaling; and deactivates the semi-static configuration via one or more of UE specific signaling or broadcast signaling;

The controller 1506 may manage input and output signals for the NE 1500. The controller 1506 may also manage peripherals not integrated into the NE 1500. In some implementations, the controller 1506 may utilize an operating system such as iOS®, ANDROID®, WINDOWS®, or other operating systems. In some implementations, the controller 1506 may be implemented as part of the processor 1502.

In some implementations, the NE 1500 may include at least one transceiver 1508. In some other implementations, the NE 1500 may have more than one transceiver 1508. The transceiver 1508 may represent a wireless transceiver. The transceiver 1508 may include one or more receiver chains 1510, one or more transmitter chains 1512, or a combination thereof.

A receiver chain 1510 may be configured to receive signals (e.g., control information, data, packets) over a wireless medium. For example, the receiver chain 1510 may include one or more antennas to receive a signal over the air or wireless medium. The receiver chain 1510 may include at least one amplifier (e.g., a low-noise amplifier (LNA)) configured to amplify the received signal. The receiver chain 1510 may include at least one demodulator configured to demodulate the receive signal and obtain the transmitted data by reversing the modulation technique applied during transmission of the signal. The receiver chain 1510 may include at least one decoder for decoding the demodulated signal to receive the transmitted data.

A transmitter chain 1512 may be configured to generate and transmit signals (e.g., control information, data, packets). The transmitter chain 1512 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1512 may also include at least one power amplifier configured to amplify the modulated signal to an appropriate power level suitable for transmission over the wireless medium. The transmitter chain 1512 may also include one or more antennas for transmitting the amplified signal into the air or wireless medium.

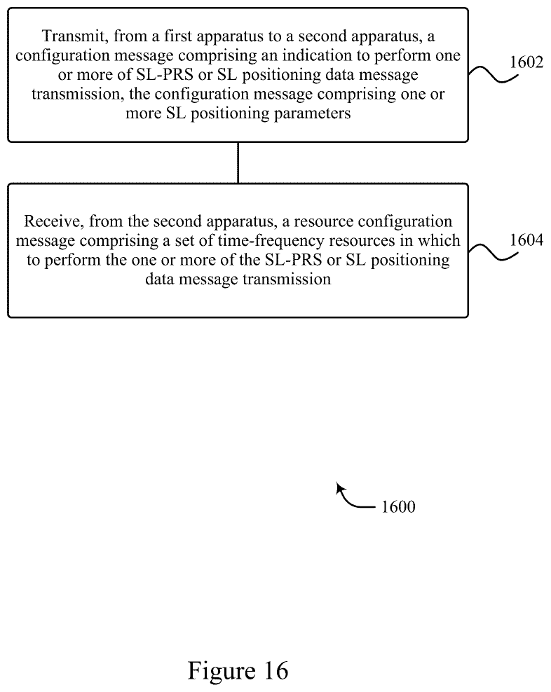

FIG. 16 illustrates a flowchart of a method 1600 in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

At 1602, the method may include transmitting, from a first apparatus to a second apparatus, a configuration message comprising an indication to perform one or more of sidelink positioning reference signal (SL-PRS) or SL positioning data message transmission, the configuration message comprising one or more SL positioning parameters. The operations of 1602 may be performed in accordance with examples as described herein. In some implementations, aspects of the operations of 1602 may be performed by a UE as described with reference to FIG. 13.

At 1604, the method may include receiving, from the second apparatus, a resource configuration message comprising a set of time-frequency resources in which to perform the one or more of the SL-PRS or SL positioning data message transmission. The operations of 1604 may be performed in accordance with examples as described herein. In some implementations, aspects of the operations of 1604 may be performed by a UE as described with reference to FIG. 13.

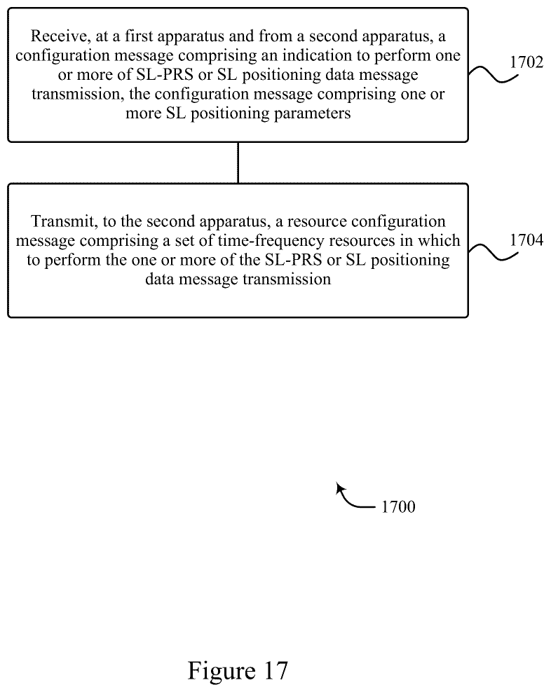

FIG. 17 illustrates a flowchart of a method 1700 in accordance with aspects of the present disclosure. The operations of the method may be implemented by a NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 1702, the method may include receiving, at a first apparatus and from a second apparatus, a configuration message comprising an indication to perform one or more of sidelink positioning reference signal (SL-PRS) or SL positioning data message transmission, the configuration message comprising one or more SL positioning parameters. The operations of 1702 may be performed in accordance with examples as described herein. In some implementations, aspects of the operations of 1702 may be performed by a NE as described with reference to FIG. 15.

At 1704, the method may include transmitting, to the second apparatus, a resource configuration message comprising a set of time-frequency resources in which to perform the one or more of the SL-PRS or SL positioning data message transmission. The operations of 1704 may be performed in accordance with examples as described herein. In some implementations, aspects of the operations of Zx04 may be performed by a NE as described with reference to FIG. 15.

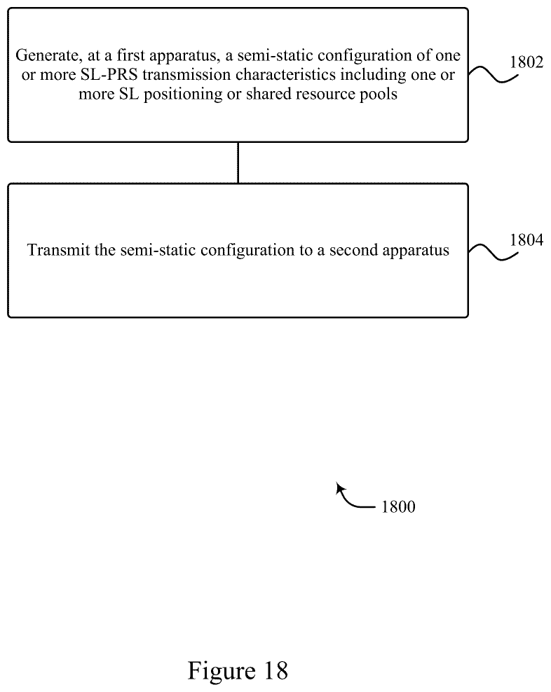

FIG. 18 illustrates a flowchart of a method 1800 in accordance with aspects of the present disclosure. The operations of the method may be implemented by a NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 1802, the method may include generating, at a first apparatus, a semi-static configuration of one or more sidelink positioning reference signal (SL-PRS) transmission characteristics including one or more SL positioning or shared resource pools. The operations of 1802 may be performed in accordance with examples as described herein. In some implementations, aspects of the operations of 1802 may be performed by a NE as described with reference to FIG. 15.

At 1804, the method may include transmitting the semi-static configuration to a second apparatus. The operations of 1804 may be performed in accordance with examples as described herein. In some implementations, aspects of the operations of 1804 may be performed by a NE as described with reference to FIG. 15.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A first apparatus comprising:
at least one memory; and
at least one processor coupled with the at least one memory and configured to cause the first apparatus to:
transmit, to a second apparatus, a configuration message comprising an indication to perform one or more of sidelink positioning reference signal (SL-PRS) or SL positioning data message transmission, the configuration message comprising one or more SL positioning parameters; and
receive, from the second apparatus, a resource configuration message comprising a set of time-frequency resources in which to perform the one or more of the SL-PRS or SL positioning data message transmission.

2. The first apparatus of claim 1, wherein the at least one processor is configured to cause the first apparatus to receive a higher-layer trigger to perform the one or more of the SL-PRS or SL positioning data message transmission.

3. The first apparatus of claim 2, wherein the higher-layer trigger comprises one or more of sidelink positioning protocol (SLPP) layer, vehicle to everything (V2X) layer, ProSe layer, ranging layer, SL positioning layer, or sidelink positioning application layer.

4. The first apparatus of claim 2, wherein the at least one processor is configured to cause the first apparatus to receive the higher-layer trigger from a UE via one or more of:
higher-layer signaling comprising one or more of sidelink positioning protocol layer (SLPP), PC5 radio resource control (RRC), or PC5-S; or
lower layer signaling comprising one or more of first stage sidelink control information (SCI), first stage medium access control (MAC) control element (CE), second stage SCI, or second stage MAC CE.

5. The first apparatus of claim 1, wherein the configuration message comprises one or more of a SL positioning quality of service (QoS) profile, at least one transport QoS profile indicating SL positioning transport QoS parameters, a SL positioning session identifier, SL-PRS transmission characteristics, or one or more UE discovered for SL positioning.

6. The first apparatus of claim 1, wherein the at least one processor is configured to cause the first apparatus to receive a system information message comprising one or more common SL positioning configurations, the one or more common SL positioning configurations comprising at least one of a SL positioning radio bearer configuration list, SL-PRS priority, positioning message priority, SL positioning frequency information list, SL-PRS/SL positioning area validity information or SL positioning measurement common information.

7. The first apparatus of claim 1, wherein the first apparatus comprises one or more of a target user equipment (UE), an anchor UE, a server UE, or an apparatus configured to perform one or more of SL-PRS or SL positioning data message transmission.

8. The first apparatus of claim 1, wherein the configuration message comprises one or more of:
a SL positioning transmission resource request;
at least one of a SL positioning receiver unicast, groupcast, or broadcast destination list;
one or more of a SL positioning transmitter or receiver frequency list;
SL positioning user equipment (UE) type;
one or more SL positioning capabilities;
a SL positioning transmission resource discovery request;
a SL positioning destination identifier;
a SL positioning cast type; or
a coverage status of a discovered UE.

9. The first apparatus of claim 1, wherein the configuration message comprises one or more of SL-PRS dedicated shared pools for at least one of mode 1 and Scheme 1 transmission or mode 2 and scheme 2 transmission.

10. The first apparatus of claim 1, wherein the configuration message comprises one or more SL-PRS and SL communication data dedicated resource pools for at least one of mode 1 and Scheme 1 transmission or mode 2 and scheme 2 transmission.

11. The first apparatus of claim 1, wherein the configuration message comprises a coverage status indication of a set of discovered user equipment (UE), and wherein the coverage status indication comprises whether each discovered UE is in coverage or out of coverage.

12. A processor for wireless communication, comprising:
at least one controller coupled with at least one memory and configured to cause the processor to:
transmit, from a first apparatus to a second apparatus, a configuration message comprising an indication to perform one or more of sidelink positioning reference signal (SL-PRS) or SL positioning data message transmission, the configuration message comprising one or more SL positioning parameters; and
receive, from the second apparatus, a resource configuration message comprising a set of time-frequency resources in which to perform the one or more of the SL-PRS or SL positioning data message transmission.

13. The processor of claim 12, wherein the at least one controller is configured to cause the processor to receive a higher-layer trigger to perform the one or more of the SL-PRS or SL positioning data message transmission.

14. The processor of claim 13, wherein the higher-layer trigger comprises one or more of sidelink positioning protocol (SLPP) layer, vehicle to everything (V2X) layer, ProSe layer, ranging layer, SL positioning layer, or sidelink positioning application layer.

15. The processor of claim 13, wherein the at least one controller is configured to cause the processor to receive the higher-layer trigger from a user equipment (UE) via one or more of:
higher-layer signaling comprising one or more of sidelink positioning protocol layer (SLPP), PC5 radio resource control (RRC), or PC5-S; or
lower layer signaling comprising one or more of first stage sidelink control information (SCI), first stage medium access control (MAC) control element (CE), second stage SCI, or second stage MAC CE.

16. The processor of claim 12, wherein the configuration message comprises one or more of a SL positioning quality of service (QoS) profile, at least one transport QoS profile indicating SL positioning transport QoS parameters, a SL positioning session identifier, SL-PRS transmission characteristics, or one or more user equipment (UE) discovered for SL positioning.

17. The processor of claim 12, wherein the at least one controller is configured to cause the processor to receive a system information message comprising one or more common SL positioning configurations, the one or more common SL positioning configurations comprising at least one of a SL positioning radio bearer configuration list, SL-PRS priority, positioning message priority, SL positioning frequency information list, SL-PRS/SL positioning area validity information or SL positioning measurement common information.

18. The processor of claim 12, wherein the first apparatus comprises one or more of a target user equipment (UE), an anchor UE, a server UE, or an apparatus configured to perform one or more of SL-PRS or SL positioning data message transmission.

19. A user equipment (UE) for wireless communication, comprising:
at least one memory; and
at least one processor coupled with the at least one memory and configured to cause the UE to:
transmit, to a second apparatus, a configuration message comprising an indication to perform one or more of sidelink positioning reference signal (SL-PRS) or SL positioning data message transmission, the configuration message comprising one or more SL positioning parameters; and
receive, from the second apparatus, a resource configuration message comprising a set of time-frequency resources in which to perform the one or more of the SL-PRS or SL positioning data message transmission.

20. A network equipment for wireless communication, comprising:
at least one memory; and
at least one processor coupled with the at least one memory and configured to cause the network equipment to:
receive, from a second apparatus, a configuration message comprising an indication to perform one or more of sidelink positioning reference signal (SL-PRS) or SL positioning data message transmission, the configuration message comprising one or more SL positioning parameters; and
transmit, to the second apparatus, a resource configuration message comprising a set of time-frequency resources in which to perform the one or more of the SL-PRS or SL positioning data message transmission.
